(19) United States
(12) Patent Application Publication
(10) Pub. No.: US 2024/0393608 A1
(43) Pub. Date: Nov. 28, 2024

(54) MULTISPECTRAL IMAGER

(71) Applicant: ILLUMINA, INC., San Diego, CA (US)

(72) Inventors: Steven Boege, San Mateo, CA (US); Stanley Hong, Palo Alto, CA (US)

(21) Appl. No.: 18/670,935

(22) Filed: May 22, 2024

Related U.S. Application Data
(60) Provisional application No. 63/469,120, filed on May 26, 2023.

(51) Int. Cl. G02B 27/14; G02B 13/18; G02B 27/00

(52) U.S. Cl. CPC G02B 27/141; G02B 13/18; G02B 27/0025

(57) ABSTRACT

An apparatus includes a sample stage region, an optical assembly, and a camera assembly. The optical assembly includes an objective element, a tube lens, a first dichroic element, and a compensating element. The objective element provides a field of view including the object plane. The tube lens is configured to receive light transmitted through the objective element. The optical assembly is configured to transmit light in at least a first color channel, a second color channel, a third color channel, and a fourth color channel from the tube lens toward the first dichroic element. The first dichroic element is configured to transmit light of the first and third color channels while reflecting light of the second and fourth color channels. The compensating element is configured to induce an astigmatism in the first and third color channels offsetting an astigmatism induced by the dichroic element.

### PRIORITY

This application claims priority to U.S. Provisional Pat. App. No. 63/469,120, entitled “Multi spectral Imager,” filed May 26, 2023, the disclosure of which is incorporated by reference herein, in its entirety.

### BACKGROUND

Aspects of the present disclosure relate generally to devices, systems, and methods providing biological or chemical analysis. Various protocols in biological or chemical research involve performing a large number of controlled reactions on local support surfaces or within predefined reaction chambers. The designated reactions may then be observed or detected, and subsequent analysis may help identify or reveal properties of chemicals involved in the reaction. For example, in some multiplex assays, an unknown analyte having an identifiable label (e.g., fluorescent label) may be exposed to thousands of known probes under controlled conditions. Each known probe may be deposited into a corresponding well of a flow cell channel. Observing any chemical reactions that occur between the known probes and the unknown analyte within the wells may help identify or reveal properties of the analyte. Other examples of such protocols include known DNA sequencing processes, such as sequencing-by-synthesis (SBS) or cyclic-array sequencing.

While a variety of devices, systems, and methods have been made and used to perform biological or chemical analysis, it is believed that no one prior to the inventor(s) has made or used the devices and techniques described herein.

### BRIEF DESCRIPTION OF THE DRAWINGS

FIG. 1 depicts a schematic view of an example of a system that may be used to provide biological or chemical analysis.

FIG. 2 depicts a schematic view of an example of a set of components that may cooperate to provide a fluid path in the system of FIG. 1.

FIG. 3 depicts a schematic view of another example of a system that may be used to provide biological or chemical analysis.

FIG. 4 depicts a cross-sectional view of an example of a flow cell that may be used in the system of FIG. 1.

FIG. 5 depicts a cross-sectional view of another example of a flow cell that may be used in the system of FIG. 1.

FIG. 6 depicts a top plan view of the flow cell of FIG. 5, with an upper wafer omitted to reveal a lower wafer.

FIG. 7 depicts a schematic view of another example of a system that may be used to provide biological or chemical analysis.

FIG. 8 depicts a schematic view of an example of imaging components that may be integrated into the system of FIG. 7.

FIG. 9 depicts a schematic view of another example of imaging components that may be integrated into the system of FIG. 7.

FIG. 10 depicts a schematic view of another example of imaging components that may be integrated into the system of FIG. 7.

FIG. 11 depicts a schematic view of an example of a color separation assembly into any of the imaging systems or imaging assemblies described herein.

FIG. 12 depicts a schematic view of an example of a color separation assembly positioned within a collimated space between an objective lens assembly and a tube lens assembly.

FIG. 13 depicts a schematic view of an example of an arrangement of imaging components including a color separation assembly, the view being provided along an x-z plane.

FIG. 14 depicts a schematic view of the imaging components of FIG. 13, the view being provided along an x-y plane.

FIG. 15 depicts a schematic perspective view of the imaging components of FIG. 13.

FIG. 16 depicts a schematic view of an example of another arrangement of imaging components including a color separation assembly, the view being provided along an x-z plane.

FIG. 17 depicts a schematic view of the imaging components of FIG. 16, the view being provided along an x-y plane.

FIG. 18 depicts a schematic view of an arrangement of imaging components including a beam separating element.

### DETAILED DESCRIPTION

The following detailed description of certain examples will be better understood when read in conjunction with the appended drawings. To the extent that the figures illustrate diagrams of the functional blocks of various examples, the functional blocks are not necessarily indicative of the division between hardware components. Thus, for example, one or more of the functional blocks (e.g., processors or memories) may be implemented in a single piece of hardware (e.g., a general purpose signal processor or random access memory, hard disk, or the like). Similarly, the programs may be stand-alone programs, may be incorporated as subroutines in an operating system, may be functions in an installed software package, and the like. It should be understood that the various examples are not limited to the arrangements and instrumentality shown in the drawings.

### I. Overview of System for Biological or Chemical Analysis

Examples described herein may be used in various biological or chemical processes and systems for academic analysis, commercial analysis, or other analysis. More specifically, examples described herein may be used in various processes and systems where it is desired to detect an event, property, quality, or characteristic that is indicative of a designated reaction. Bioassay systems such as those described herein may be configured to perform a plurality of designated reactions that may be detected individually or collectively. For example, bioassay systems may be used to sequence a dense array of nucleic acid features through iterative cycles of enzymatic manipulation and image acquisition. In some examples, nucleic acids can be attached to a surface and amplified. Examples of such amplification are described in U.S. Pat. No. 7,741,463, entitled “Method of Preparing Libraries of Template Polynucleotides,” issued Jun. 22, 2010, the disclosure of which is incorporated by reference herein, in its entirety; and/or U.S. Pat. No. 7,270,981, entitled “Recombinase Polymerase Amplification,” issued Sep. 18, 2007, the disclosure of which is incorporated by reference herein, in its entirety.

Components that are used in the bioassay systems may include one or more microfluidic channels that deliver reagents or other reaction components to a reaction site. The reaction sites may be randomly distributed across a substantially planar surface; or may be patterned across a substantially planar surface. Each of the reaction sites may be imaged to detect light from the reaction site. The signals indicating photons emitted from the reaction sites and detected by image sensors may provide illumination values. These illumination values may be combined into an image indicating photons as detected from the reaction sites. These images may be further analyzed to identify compositions, reactions, conditions, etc., at each reaction site.

### II. Examples of Fluidics Devices and Fluid Flow Paths

A. Example of System with Higher Volume Throughput

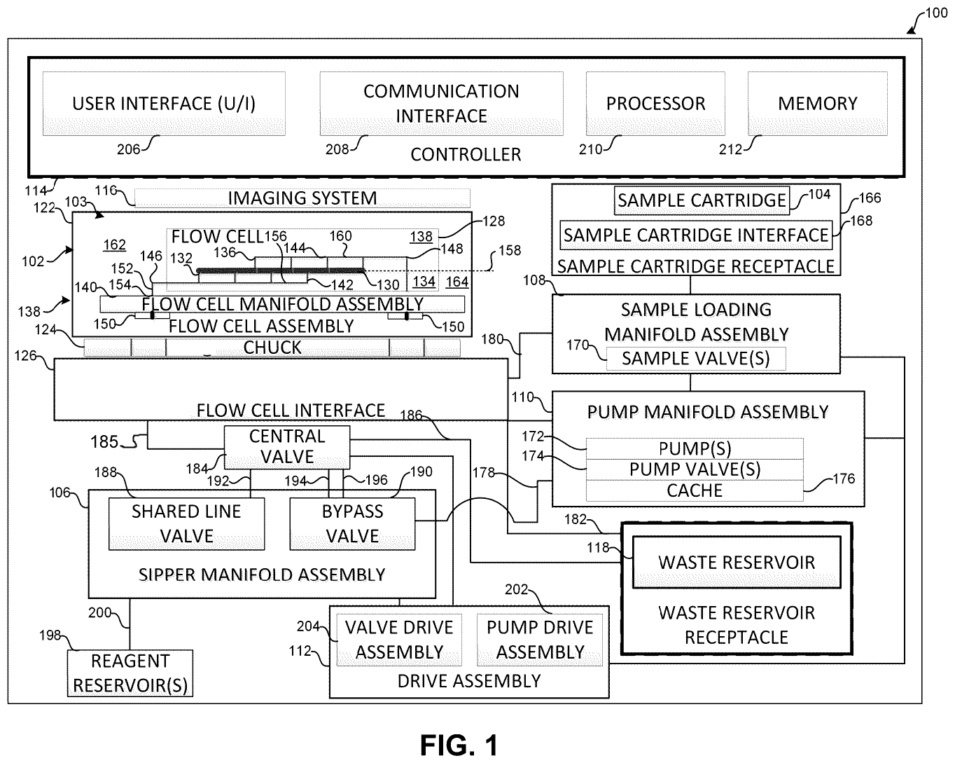

FIG. 1 illustrates a schematic diagram of an example of a system (100) that may be used to perform an analysis on one or more samples of interest. In some implementations, the sample may include one or more clusters of nucleotides (e.g., DNA) that have been linearized to form a single stranded DNA (sstDNA). In the implementation shown, system (100) is configured to receive a flow cell cartridge assembly (102) including a flow cell assembly (103) and a sample cartridge (104). System (100) includes a flow cell receptacle (122) that receives flow cell cartridge assembly (102), a vacuum chuck (124) that supports flow cell assembly (103), and a flow cell interface (126) that is used to establish a fluidic coupling between system (100) and flow cell assembly (103). Flow cell interface (126) may include one or more manifolds. System (100) further includes a sipper manifold assembly (106), a sample loading manifold assembly (108), and a pump manifold assembly (110). System (100) also includes a drive assembly (112), a controller (114), an imaging system (116), and a waste reservoir (118). Controller (114) is electrically and/or communicatively coupled to drive assembly (112) and to imaging system (116); and is configured to cause drive assembly (112) and/or the imaging system (116) to perform various functions as disclosed herein.

In the present example, flow cell assembly (103) includes a flow cell (128) having a channel (130) and defining a plurality of first openings (132), which are fluidically coupled to the channel (130) and arranged on a first side (134) of the channel (130). Flow cell (128) further includes a plurality of second openings (136) fluidically coupled to the channel (130) and arranged on a second side (138) of the channel (130). Fluid may thus flow through flow cell (128) via channel. While the flow cell (128) is shown including one channel (130), flow cell (128) may include two or more channels (130). Flow cell assembly (103) also includes a flow cell manifold assembly (140) coupled to flow cell (128) and having a first manifold fluidic line (142) and a second manifold fluidic line (144). Flow cell manifold assembly (140) may be in the form of a laminate including a plurality of layers as discussed in more detail below.

In the implementation shown, first manifold fluidic line (142) has a first fluidic line opening (146) and is fluidically coupled to each of the first openings (132) of flow cell (128); and second manifold fluidic line (144) has a second fluidic line opening (148) and is fluidically coupled to each of the second openings (136). As shown, flow cell assembly (103) includes gaskets (150) coupled to flow cell manifold assembly (140) and fluidically coupled to fluidic line openings (146, 148). In some implementations where flow cell (128) includes a plurality of channels (130), flow cell manifold assembly (140) may include additional fluidic lines (152) that couple first fluidic line openings (146) to a single manifold port (154). In such implementations, a single gasket (150) may be coupled to flow cell manifold assembly (140) that surrounds the manifold port (154) and is in fluidic communication with a plurality of channels (130). In operation, flow cell interface (126) engages with corresponding gaskets (150) to establish a fluidic coupling between system (100) and flow cell (128). The engagement between flow cell interface (126) and gaskets (150) reduces or eliminates fluid leakage between flow cell interface (126) and flow cell (128).

In the implementation shown, first manifold fluidic line (142) has a portion (156) that is substantially parallel to a longitudinal axis (158) of channel (130); and second manifold fluidic line (144) has a portion (160) that is substantially parallel to longitudinal axis (158) of channel (130). Additionally, first manifold fluidic line (142) is shown being at least partially adjacent a first end (162) of flow cell (128) and spaced from a second end (164) of flow cell (128); and second manifold fluidic line (144) is shown being at least partially adjacent second end (164) of flow cell (128) and spaced from first end (162). Other arrangements of manifold fluidic lines (142, 144) may prove suitable, however.

In the implementation shown, system (100) includes a sample cartridge receptacle (166) that receives sample cartridge (104) that carries one or more samples of interest (e.g., an analyte). System (100) also includes a sample cartridge interface (168) that establishes a fluidic connection with sample cartridge (104). Sample loading manifold assembly (108) includes one or more sample valves (170). Pump manifold assembly (110) includes one or more pumps (172), one or more pump valves (174), and a cache (176). Valves (170, 174) and pumps (172) may take any suitable form. Cache (176) may include a serpentine cache and may temporarily store one or more reaction components during, for example, bypass manipulations of the system (100). While cache (176) is shown being included in pump manifold assembly (110), cache (176) may alternatively be located elsewhere (e.g., in sipper manifold assembly (106) or in another manifold downstream of a bypass fluidic line (178), etc.).

Sample loading manifold assembly (108) and pump manifold assembly (110) flow one or more samples of interest from sample cartridge (104) through a fluidic line (180) toward flow cell cartridge assembly (102). In some implementations, sample loading manifold assembly (108) may individually load or address each channel (130) of flow cell (128) with a respective sample of interest. The process of loading channel (130) with a sample of interest may occur automatically using system (100). As shown in FIG. 1, sample cartridge (104) and sample loading manifold assembly (108) are positioned downstream of flow cell cartridge assembly (102). In the implementation shown, sample loading manifold assembly (108) is coupled between flow cell cartridge assembly (102) and pump manifold assembly (110). To draw a sample of interest from sample cartridge (104) and toward pump manifold assembly (110), sample valves (170), pump valves (174), and/or pumps (172) may be selectively actuated to urge the sample of interest toward pump manifold assembly (110). Sample cartridge (104) may include a plurality of sample reservoirs that are selectively fluidically accessible via the corresponding sample valves (170). To individually flow the sample of interest toward channel (130) of flow cell (128) and away from pump manifold assembly (110), sample valves (170), pump valves (174), and/or pumps (172) may be selectively actuated to urge the sample of interest toward flow cell cartridge assembly (102) and into respective channels (130) of flow cell (128).

Drive assembly (112) interfaces with sipper manifold assembly (106) and pump manifold assembly (110) to flow one or more reagents that interact with the sample within flow cell (128). In some scenarios, a reversible terminator is attached to the reagent to allow a single nucleotide to be incorporated onto a growing DNA strand. In some such implementations, one or more of the nucleotides has a unique fluorescent label that emits a color when excited. The color (or absence thereof) is used to detect the corresponding nucleotide. In the implementation shown, imaging system (116) excites one or more of the identifiable labels (e.g., a fluorescent label) and thereafter obtains image data for the identifiable labels. The labels may be excited by incident light and/or a laser and the image data may include one or more colors emitted by the respective labels in response to the excitation. The image data (e.g., detection data) may be analyzed by system (100). Examples of features and functionalities that may be incorporated into imaging system (116) will be described in greater detail below.

After the image data is obtained, drive assembly (112) interfaces with sipper manifold assembly (106) and pump manifold assembly (110) to flow another reaction component (e.g., a reagent) through flow cell (128) that is thereafter received by waste reservoir (118) via a primary waste fluidic line (182) and/or otherwise exhausted by system (100). Some reaction components may perform a flushing operation that chemically cleaves the fluorescent label and the reversible terminator from the sstDNA. The sstDNA may then be ready for another cycle.

The primary waste fluidic line (182) is coupled between pump manifold assembly (110) and waste reservoir (118). In some implementations, pumps (172) and/or pump valves (174) of pump manifold assembly (110) selectively flow the reaction components from flow cell cartridge assembly (102), through fluidic line (180) and sample loading manifold assembly (108) to primary waste fluidic line (182). Flow cell cartridge assembly (102) is coupled to a central valve (184) via flow cell interface (126). Central valve (184) is coupled with flow cell interface (126) via a fluidic line (185). An auxiliary waste fluidic line (186) is coupled to central valve (184) and to waste reservoir (118). In some implementations, auxiliary waste fluidic line (186) receives excess fluid of a sample of interest from flow cell cartridge assembly (102), via central valve (184), and flows the excess fluid of the sample of interest to waste reservoir (118) when back loading the sample of interest into flow cell (128), as described herein.

Sipper manifold assembly (106) includes a shared line valve (188) and a bypass valve (190). Shared line valve (188) may be referred to as a reagent selector valve. Central valve (184) and the valves (188, 190) of sipper manifold assembly (106) may be selectively actuated to control the flow of fluid through fluidic lines (192, 194, 196). Sipper manifold assembly (106) may be coupled to a corresponding number of reagent reservoirs (198) via reagent sippers (200). Reagent reservoirs (198) may contain fluid (e.g., reagent and/or another reaction component). In some implementations, sipper manifold assembly (106) includes a plurality of ports. Each port of sipper manifold assembly (106) may receive one of the reagent sippers (200). Reagent sippers (200) may be referred to as fluidic lines. Some forms of reagent sippers (200) may include an array of sipper tubes extending downwardly along the z-dimension from ports in the body of sipper manifold assembly (106). Reagent reservoirs (198) may be provided in a cartridge, and the tubes of reagent sippers (200) may be configured to be inserted into corresponding reagent reservoirs (198) in the reagent cartridge so that liquid reagent may be drawn from each reagent reservoir (198) into the sipper manifold assembly (106).

Shared line valve (188) of sipper manifold assembly (106) is coupled to central valve (184) via shared reagent fluidic line (196). Different reagents may flow through shared reagent fluidic line (196) at different times. In some versions, when performing a flushing operation before changing between one reagent and another, pump manifold assembly (110) may draw wash buffer through shared reagent fluidic line (196), central valve (184), and flow cell cartridge assembly (102).

Bypass valve (190) of sipper manifold assembly (106) is coupled to central valve (184) via dedicated reagent fluidic lines (194, 196). Each of the dedicated reagent fluidic lines (194, 196) may be associated with a single reagent. The fluids that may flow through dedicated reagent fluidic lines (194, 196) may be used during sequencing operations and may include a cleave reagent, an incorporation reagent, a scan reagent, a cleave wash, and/or a wash buffer.

Bypass valve (190) is also coupled to cache (176) of pump manifold assembly (110) via bypass fluidic line (178). One or more reagent priming operations, hydration operations, mixing operations, and/or transfer operations may be performed using bypass fluidic line (178). The priming operations, the hydration operations, the mixing operations, and/or the transfer operations may be performed independent of flow cell cartridge assembly (102). Thus, the operations using bypass fluidic line (178) may occur during, for example, incubation of one or more samples of interest within flow cell cartridge assembly (102). That is, shared line valve (188) may be utilized independently of bypass valve (190) such that bypass valve (190) may utilize bypass fluidic line (178) and/or cache (176) to perform one or more operations while shared line valve (188) and/or central valve (184) simultaneously, substantially simultaneously, or offset synchronously perform other operations.

Drive assembly (112) includes a pump drive assembly (202) and a valve drive assembly (204). Pump drive assembly (202) may be adapted to interface with one or more pumps (172) to pump fluid through flow cell (128) and/or to load one or more samples of interest into flow cell (128). Valve drive assembly (204) may be adapted to interface with one or more of the valves (170, 174, 184, 188, 190) to control the position of the corresponding valves (170, 174, 184, 188, 190).

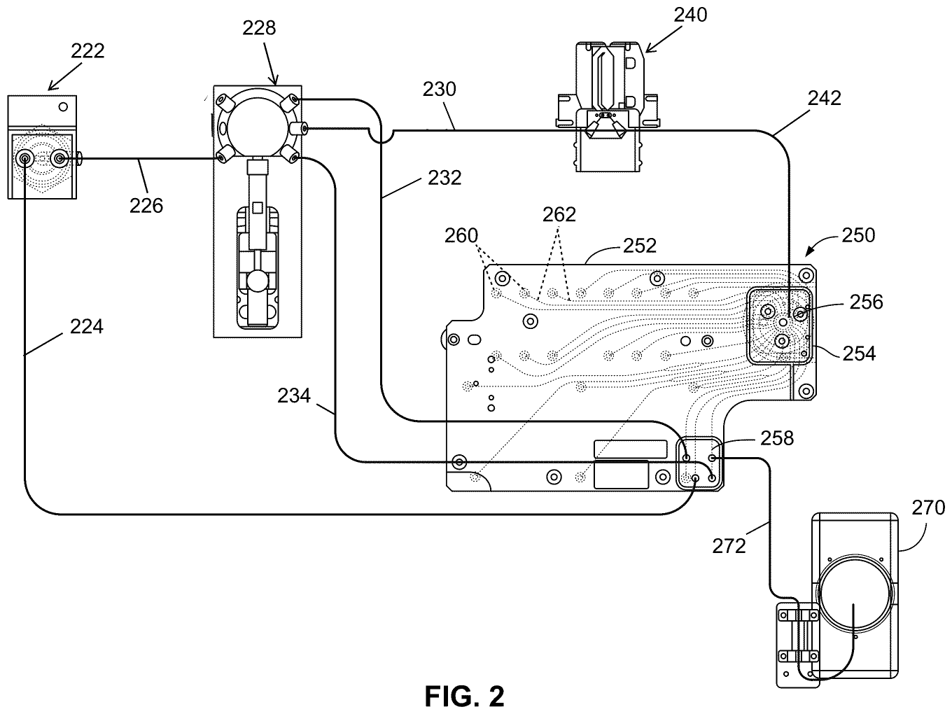

FIG. 2 shows an example of a fluidic arrangement (220) that may be incorporated into a variation of system (100). Fluidic arrangement (220) of this example includes a pump manifold assembly (222), which may operate similar to pump manifold assembly (110) described above; a sample loading manifold assembly (228), which may operate similar to sample loading manifold assembly (108) described above; a flow cell interface (240), which may operate similar to flow cell interface (126) described above; a sipper manifold assembly (250), which may operate similar to sipper manifold assembly (106) described above; and a waste reservoir (270), which may operate similar to waste reservoir (118) described above. Pump manifold assembly (222) is coupled with a port assembly (258) of sipper manifold assembly (250) via a fluidic line (224), which may be similar to fluidic line (178); and with sample loading manifold assembly (228) via a fluidic line (226). Sample loading manifold assembly (228) is coupled with flow cell interface (240) via fluidic line (230), which may be similar to fluidic line (180); and with port assembly (258) via fluidic lines (232, 234). Flow cell interface (240) is coupled with sipper manifold assembly (250) via fluidic line (242), which may be similar to fluidic line (185). Sipper manifold assembly (250) includes a manifold body (252) and a common output port (256), which provides fluid communication via fluidic line (185). A valve assembly (254) controls fluid flow through common output port (256) and may operate similar to central valve (184). Port assembly (258) of sipper manifold assembly (250) is coupled with waste reservoir (270) via fluidic line (272), which may be similar to fluidic line (186).

A plurality of reagent sippers (260) extend from manifold body (252) and are fluidically coupled with valve assembly (254) via respective fluid channels (262) in manifold body (252). Reagent sippers (260) may operate similar to reagent sippers (200). Valve assembly (254) is operable to selectively couple fluid channels (262) with flow cell interface (240) via common output port (256) and fluidic line (230), to thereby selectively provide various reagents to flow cell interface (240). In other words, when each reagent sipper (260) is disposed in a different respective reagent (e.g., in a respective reagent reservoir (198)), a flow cell (e.g., like flow cell (128)) that is coupled with flow cell interface (240) may selectively receive those different reagents based on control of valve assembly (254).

Port assembly (258) may provide a fluidic interface between pump manifold assembly (222) and sipper manifold assembly (250), thereby allowing sipper manifold assembly (250) to receive pressurized fluid from pump manifold assembly (222). Port assembly (258) may also provide a fluidic interface between sample loading manifold assembly (228) and sipper manifold assembly (250), thereby allowing sipper manifold assembly (250) to receive sample fluid from sample loading manifold assembly (228). In addition, port assembly (258) may provide a fluidic interface between waste reservoir (270) and sipper manifold assembly (250), thereby allowing sipper manifold assembly (250) to communicate waste fluid to waste reservoir (270). Communication of fluids via port assembly (258) may be regulated, at least in part, by valve assembly (254).

Referring back to FIG. 1, controller (114) of the present example includes a user interface (206), a communication interface (208), one or more processors (210), and a memory (212) storing instructions executable by the one or more processors (210) to perform various functions including the disclosed implementations. User interface (206), communication interface (133), and memory (212) are electrically and/or communicatively coupled to the one or more processors (210). User interface (206) may be adapted to receive input from a user and to provide information to the user associated with the operation of system (100) and/or an analysis taking place. User interface (206) may include a touch screen, a display, a keyboard, a speaker(s), a mouse, a track ball, and/or a voice recognition system.

Communication interface (208) is adapted to enable communication between system (100) and a remote system(s) (e.g., computers) via a network(s) (e.g., the Internet, an intranet, a local-area network (LAN), a wide-area network (WAN), a coaxial-cable network, a wireless network, a wired network, a satellite network, a digital subscriber line (DSL) network, a cellular network, a Bluetooth connection, a near field communication (NFC) connection, etc.). Some of the communications provided to the remote system may be associated with analysis results, imaging data, etc. generated or otherwise obtained by system (100). Some of the communications provided to system (100) may be associated with a fluidics analysis operation, patient records, and/or a protocol(s) to be executed by system (100).

The one or more processors (210) and/or system (100) may include one or more of a processor-based system(s) or a microprocessor-based system(s). In some implementations, the one or more processors (210) and/or system (100) includes one or more of a programmable processor, a programmable controller, a microprocessor, a microcontroller, a graphics processing unit (GPU), a digital signal processor (DSP), a reduced-instruction set computer (RISC), an application specific integrated circuit (ASIC), a field programmable gate array (FPGA), a field programmable logic device (FPLD), a logic circuit, and/or another logic-based device executing various functions including the ones described herein.

Memory (212) may include one or more of a semiconductor memory, a magnetically readable memory, an optical memory, a hard disk drive (HDD), an optical storage drive, a solid-state storage device, a solid-state drive (SSD), a flash memory, a read-only memory (ROM), erasable programmable read-only memory (EPROM), electrically erasable programmable read-only memory (EEPROM), a random-access memory (RAM), a non-volatile RAM (NVRAM) memory, a compact disc (CD), a compact disc read-only memory (CD-ROM), a digital versatile disk (DVD), a Blu-ray disk, a redundant array of independent disks (RAID) system, a cache and/or any other storage device or storage disk in which information is stored for any duration (e.g., permanently, temporarily, for extended periods of time, for buffering, for caching).

B. Example of System with Lower Volume Throughput

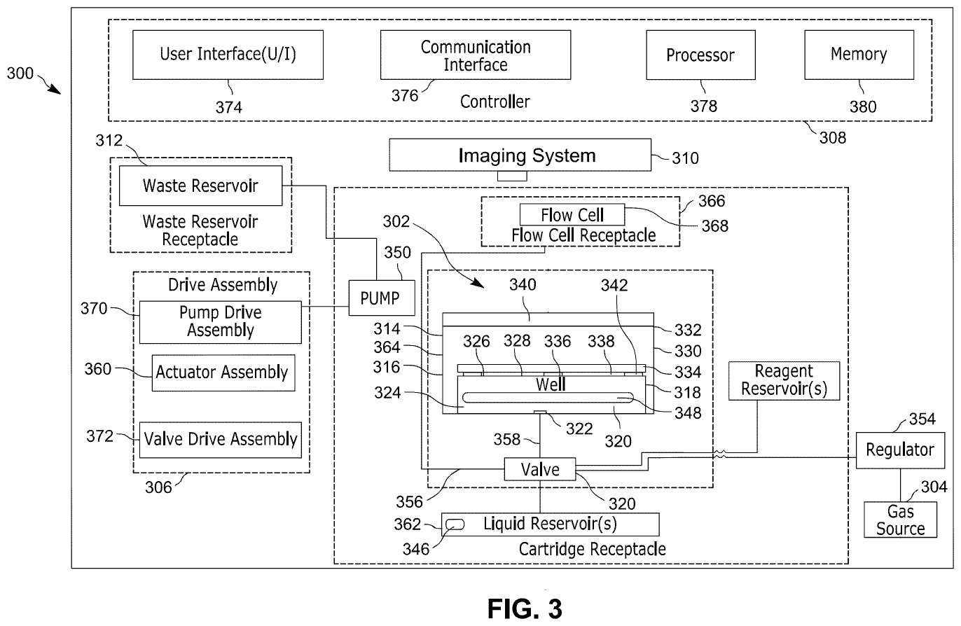

FIG. 3 illustrates a schematic diagram of another example of a system (300) that may be used to perform an analysis on one or more samples of interest. Except as otherwise described below, system (300) of this example may be configured and operable like system (100) described above with reference to FIG. 1. In some instances, system (100) is used to provide a higher volume throughput; while system (300) is used to provide a lower volume throughput. Alternatively, systems (100, 300) may provide any other suitable amount or degree of throughput. System (300) of the present example receives a reagent cartridge (302) and includes, in part, a gas source (304), a drive assembly (306), a controller (308), an imaging system (310), and a waste reservoir (312). Reagent cartridge (302) may be referred to as a consumable, a reagent reservoir, or a reagent assembly. Controller (308) is electrically and/or communicatively coupled to drive assembly (306) and to imaging system (310) and causes drive assembly (306) and/or imaging system (310) to perform various functions as disclosed herein.

Reagent cartridge (302) in the implementation shown includes a well assembly (314) having a body (316). Body (316) has a first wall (318) defining a well (320) having a port (322). First wall (318) has a distal end (324) that defines an opening (326) having an opening perimeter (328). A second wall (330) surrounds first wall (318) and has a distal end (332). Distal end (332) may be referred to as an edge or an outer edge. A cover (334) is coupled to distal end (324) of first wall (318) and covers opening (326) along opening perimeter (328) at a connected portion (336); and is uncoupled from distal end (324) of first wall (318) at an unconnected portion (338). Connection portion (336) may be referred to as connection sections or connected segments and unconnected portion (338) may be referred to as unconnected sections or unconnected segments. First wall (318) has a height and second wall (330) has a height that is greater than the height of first wall (318). First well (318) and second well (330) may alternatively be the same or similar heights. An impermeable barrier (340) is coupled to distal end (332) of second wall (330) and covers well (320). Impermeable barrier (340) may be foil, plastic, etc. and may prevent or inhibit moisture from infiltrating wells (320) of reagent cartridge (302).

Unconnected portion (338) of cover (334) forms a vent (342) that allows air flow out of well (320). Dried reagent (348) is contained within well (320), and vent (342) is sized to substantially retain dried reagent (348) within the well (320). Body (316) may include a plurality of wells (320) while one well (320) is shown in FIG. 3. Liquid (346) may flow into well (320) via port (322) in practice to rehydrate dried reagent (348). Vent (342) may vent gas from well (320) as liquid (346) flows into well (320); and cover (334) prevents or inhibits reagent (348) and/or liquid (346) from escaping from well (320). Put another way, vents (342) retain reagent (348) and/or liquid (346) within wells (320); and prevent or inhibit reagent (348) and/or liquid (346) from migrating out of wells (320). Vent (342) and cover (334) prevent or inhibit cross-contamination between reagents when reagent cartridge (302) includes more than one well (320). Liquid (346) and dried reagent (348) may be flowed into and out of well (320) to mix liquid (346) from liquid reservoir (362) and dried reagent (348). System (300) and/or reagent cartridge (302) may include a mixing chamber that is used to mix liquid (346) and dried reagent (348) in some implementations. Impermeable barrier (340) may be pierced prior to liquid (346) flowing into well (320).

Gas source (304) may be used to pressurize liquid reservoir (362) to flow liquid (346) into well (320); and/or a pump (350) may draw liquid (346) from liquid reservoir (362) and flow liquid (346) into well (320) to rehydrate reagent (348). Gas source (304) may be provided by system (300) and/or may be carried by reagent cartridge (302). Gas source (304) may alternatively be omitted. Pump (350) may be implemented by a syringe pump, a peristaltic pump, a diaphragm pump, etc. While pump (350) may be positioned downstream of flow cell (368) as shown, pump (350) may be positioned upstream of flow cell (368) or omitted entirely.

Reagent cartridge (302) and/or system (300) includes valves (352) that may be selectively actuatable to control the flow of fluid through fluidic lines (356). Such valves (352) may be implemented by a valve manifold, a rotary valve, a selector valve, a pinch valve, a flat valve, a solenoid valve, a check valve, a piezo valve, etc. A regulator (354) may be positioned between gas source (304) and valve (352); and regulate the pressure of the gas provided to valve (352). Regulator (354) may include a valve that controls the flow of the gas from gas source (304).

Body (316) of well assembly (314) has an edge (364); and impermeable barrier (340) may be hermetically connected to body (316) along edge (364). Impermeable barrier (340) may include foil, plastic, and/or any other suitable material(s). System (300) may pierce impermeable barrier (340), impermeable barrier (340) may be pierced by an individual prior to use, or impermeable barrier (340) may be pierced by some other structure or methodology. System (300) includes an actuator assembly (360) in the implementation shown that interfaces with impermeable barrier (340) to pierce impermeable barrier (340). System (300) may include a protrusion such as a post having a blunt or sharp end that is movable by actuator assembly (360) to pierce impermeable barrier (340). Impermeable barrier (340) may alternatively be pierced by an operator prior to reagent cartridge (302) being positioned in system (300). System (300) also includes a liquid reservoir (362) containing liquid (346). Liquid (346) may comprise a rehydrating liquid, a wash buffer, and/or any other suitable kind(s) of liquid.

System (300) further includes a flow cell receptacle (366) that receives a flow cell (368). Flow cell (368) may be configured and operable like flow cell (128). In some variations, flow cell (368) is carried by and/or integrated into reagent cartridge (302). Flow cell (368) may carry the sample of interest. Gas source (304) and/or pump (350) may flow liquid (346) to rehydrate dry reagents (348) and to flow one or more liquid reagents through reagent cartridge (302) that interact with the sample. Imaging system (310) may be configured and operable like imaging system (116), such that imaging system (310) may be used to obtain image data from flow cell (368). After the image data is obtained, drive assembly (306) may interface with reagent cartridge (302) to flow another reaction component (e.g., a reagent) through flow cell (368) that is thereafter received by the waste reservoir (312) and/or otherwise exhausted by reagent cartridge (302). In the present example, drive assembly (306) includes a pump drive assembly (370), a valve drive assembly (372), and actuator assembly (360). Pump drive assembly (370) interfaces with pump (350) to pump fluid through reagent cartridge (302) and/or flow cell (368); and valve drive assembly (372) interfaces with valve (352) to control the position of valve (352).

Controller (308) of this example includes a user interface (374), a communication interface (376), a processor (378), and a memory (380). User interface (374) may be configured and operable like user interface (206) of system (100). Communication interface (376) may be configured and operable like communication interface (208) of system (100). Processor (378) may be configured and operable like processor (210) of system (100). Memory (380) may be configured and operable like memory (212) of system (100).

Further examples and details of how various features of each system (100, 300) may be configured and operable will be described below. By way of further example only, the various features of system (100, 300) may be configured and operable in accordance with at least some of the teachings of International Pub. No. WO 2023/055873, entitled “Flow Cells and Related Flow Cell Manifold Assemblies and Methods,” published Apr. 6, 2023, the disclosure of which is incorporated by reference herein, in its entirety; U.S. Pat. No. 9,958,465, entitled “Detection Apparatus having a Microfluorometer, a Fluidic System, and a Flow Cell Latch Clamp Module,” issued May 1, 2018, the disclosure of which is incorporated by reference herein, in its entirety; and/or U.S. Pat. App. No. 63/325,462, entitled “Well Assemblies and Related Systems and Methods,” filed Mar. 30, 2022, the disclosure of which is incorporated by reference herein, in its entirety.

### III. Examples of Flow Cell Structures

As noted above, a system (100, 300) may execute reactions in a flow cell (128, 368) and/or perform analysis on one or more samples of interest in a flow cell (128, 368). The following describes examples of forms that such flow cells (128, 368) may take, it being understood that flow cells (128, 368) may take various other forms and have various other features in addition to or in lieu of the features described below.

### A. Example of Single-Surface Patterned Flow Cell

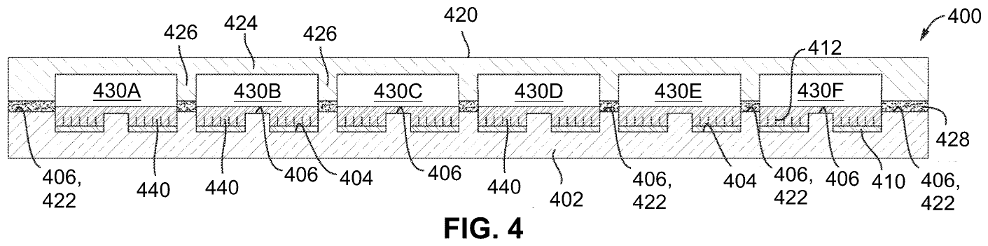

FIG. 4 shows an example of a flow cell (400) that includes a patterned substrate (402), which includes depressions (404) separated by interstitial regions (406), and surface chemistry (410, 412) positioned in the depressions (404). Depressions (404) may be in the form of microwells or nanowells. Depressions (404) may be configured to contain nucleic acid strands or other oligonucleotides and thereby provide a reaction site for SBS and/or for other kinds of processes. In some versions, each depression (404) has a cylindraceous configuration, with a generally circular cross-sectional profile. In some other versions, each depression (404) has a polygonal (e.g., hexagonal, octagonal, square, rectangular, elliptical, etc.) cross-sectional profile. Alternatively, depressions (404) may have any other suitable configuration. It should also be understood that depressions (404) may be arranged in any suitable pattern, including but not limited to a grid pattern.

Surface chemistry (410, 412) of the present example includes functionalized coating layer (410) and primers (412). While not shown, it is to be understood that the depressions (404) may also have surface preparation or treatment chemistry (e.g., silane or a silane derivative) positioned between the substrate (402) and the functionalized coating layer (410). This same surface preparation or treatment chemistry may also be positioned on the interstitial regions (406). In the present example, a hydrogel (440) is applied before lid (420) is bonded to substrate (402). Hydrogel (440) covers surface chemistry (410, 412) in depressions (404), and at least a portion of the patterned substrate (402) (e.g., those interstitial regions (406) that are not also bonding regions (422)). By way of example only, hydrogel (440) may comprise PAZAM, crosslinked polyacrylamide, agarose gel, etc.

Flow cell (400) of this example further includes a lid (420) bonded to bonding region(s) (422) of patterned substrate (402). In the example shown in FIG. 4, lid (420) includes a top portion (424) that is connected to several sidewalls (426), and these components (424, 426) define a portion of each of the six flow channels (430A, 430B, 430C, 430D, 430E, 430F). The respective sidewalls (426) isolate one flow channel (430A, 430B, 430C, 430D, 430E, 430F) from each adjacent flow channel (430A, 430B, 430C, 430D, 430E, 430F). Each flow channel (430A, 430B, 430C, 430D, 430E, 430F) is in selective fluid communication with a respective set of depressions (404).

Lid (420) may be bonded to bonding region (422) of substrate (402) using any suitable technique, such as laser bonding, diffusion bonding, anodic bonding, eutectic bonding, plasma activation bonding, glass frit bonding, or other methods known in the art. In some versions, a spacer layer (428) may be used to bond lid (420) to bonding region (422). Spacer layer (428) may comprise any material that will seal at least some of interstitial regions (404) (e.g., bonding region (422)) of substrate (402) and lid (420) together. While not shown, lid (420) or the patterned substrate (402) may include inlet and outlet ports that are to fluidically engage other ports (not shown), such as those of sample cartridge interface (168), for directing fluid(s) into the respective flow channels (430A, 430B, 430C, 430D, 430E, 430F) (e.g., from a reagent cartridge or other fluid storage system) and out of the flow channel (e.g., to waste reservoir (118) or another waste removal system). Flow channels (430A, 430B, 430C, 430D, 430E, 430F) may serve to, for example, selectively introduce reaction components or reactants to hydrogel (440) and the underlying surface chemistry (410, 412) in order initiate designated reactions in/at depressions (404).

While flow cell (400) includes a pattern of depressions (404) to provide an array of reaction sites, other variations may provide reaction sites on or at various other kinds of structural features, including but not limited to continuously planer surfaces and/or protruding surfaces, etc. By way of further example only, flow cell (400) may be constructed and operable in accordance with at least some of the teachings of U.S. Pat. No. 10,919,033, entitled “Flow Cells with Hydrogel Coating,” issued Feb. 16, 2021, the disclosure of which is incorporated by reference herein, in its entirety.

### B. Example of Dual-Surface Patterned Flow Cell

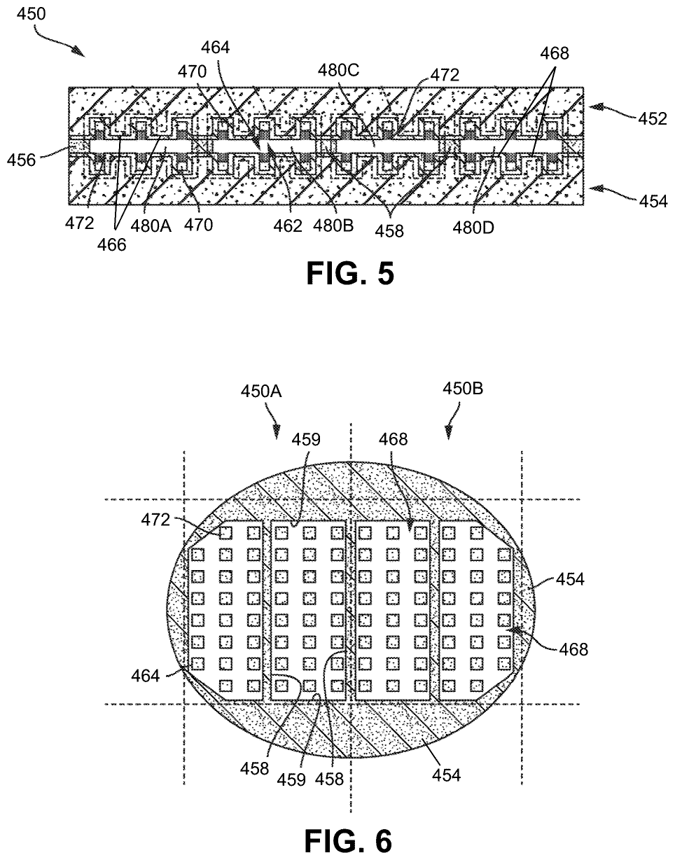

While FIG. 4 shows an example of a flow cell (400) that has a single surface patterned with reaction sites (i.e., depressions (404) formed in substrate (402)), it may be desirable in some instances to provide a variation of flow cell (400) that provide two surfaces patterned with reaction sites. An example of a dual-surface patterned flow cell (450) is shown in FIGS. 5-6. In this example, flow cell (450) includes a pair of wafers (452, 454) that are bonded together, with a spacer layer (456) interposed between wafers (452, 454). Each wafer (452, 454) is patterned to provide a respective plurality of depressions (462, 464), such that depressions (462) of wafer (452) align with depressions (464) of wafer (454) when flow cell (450) is assembled. Depressions (462) are separated from each other by interstitial regions (466); and depressions (464) are separated from each other by interstitial regions (468). Spacer layer (456) does not contact interstitial regions (466, 468) in this example.

Depressions (462, 464) of flow cell (450) may be configured and operable like depressions (404) of flow cell (400) described above. Each depression (462, 464) of the present example includes a grafted coating (470), which may be similar to functionalized coating layer (410); and primers (472), which may be similar to primers (412) described above. Each depression (462, 464) may further include hydrogel, like hydrogel (440), and/or any other suitable feature(s). As shown in FIGS. 5-6, depressions (462, 464) are provided within a plurality of flow channels (480A, 480B, 480C, 480D). Flow channels (480A, 480B, 480C, 480D) are separated from each other by walls (458) and ends (459) formed by spacer layer (456). In the example shown in FIG. 6, flow cell (450) provides four flow channels (480A, 480B, 480C, 480D), with each flow channel (480A, 480B, 480C, 480D) containing several rows and columns of depressions (462, 464). When flow cell (450) is used in system (100, 300), flow channels (480A, 480B, 480C, 480D) may serve to, for example, selectively introduce reaction components or reactants surface chemistry (470, 472) in order initiate designated reactions in/at depressions (462, 464). In some instances, since each wafer (452, 454) has its own set of depressions (462, 464) providing corresponding reaction sites, flow cell (450) may provide twice as many reactions as a similarly sized flow cell (400) during a given time period.

The broken lines in FIG. 6 indicate how flow cell (450) may be diced to effectively form smaller flow cells (450A, 450A), with each smaller flow cell (450A, 450A) having its own respective pair of flow channels (480A, 480B, 480C, 480D). In the present example, however, a single flow cell (450) has more than two flow channels (480A, 480B, 480C, 480D). While flow cell (450) includes a pattern of depressions (462, 464) to provide an array of reaction sites, other variations may provide reaction sites on or at various other kinds of structural features, including but not limited to continuously planer surfaces and/or protruding surfaces, etc. By way of further example only, flow cell (450) may be constructed and operable in accordance with at least some of the teachings of U.S. Pat. No. 10,955,332, entitled “Flow Cell Package and Method for Making the Same,” issued Mar. 23, 2021, the disclosure of which is incorporated by reference herein, in its entirety.

### IV. Examples of Imaging System Features

As noted above, system (100, 300) includes an imaging system (116, 310) that excites one or more identifiable labels (e.g., a fluorescent label) in samples in reaction sites provided by depressions (404, 462, 464) of a flow cell (128, 368, 400, 450); and thereafter obtains image data for the identifiable labels. This image data is used to identify nucleotides as part of a nucleic acid sequencing process. Alternatively, the image data may be used for various other purposes. The following description provides details on how some versions of imaging system (116, 310) may be configured and operable.

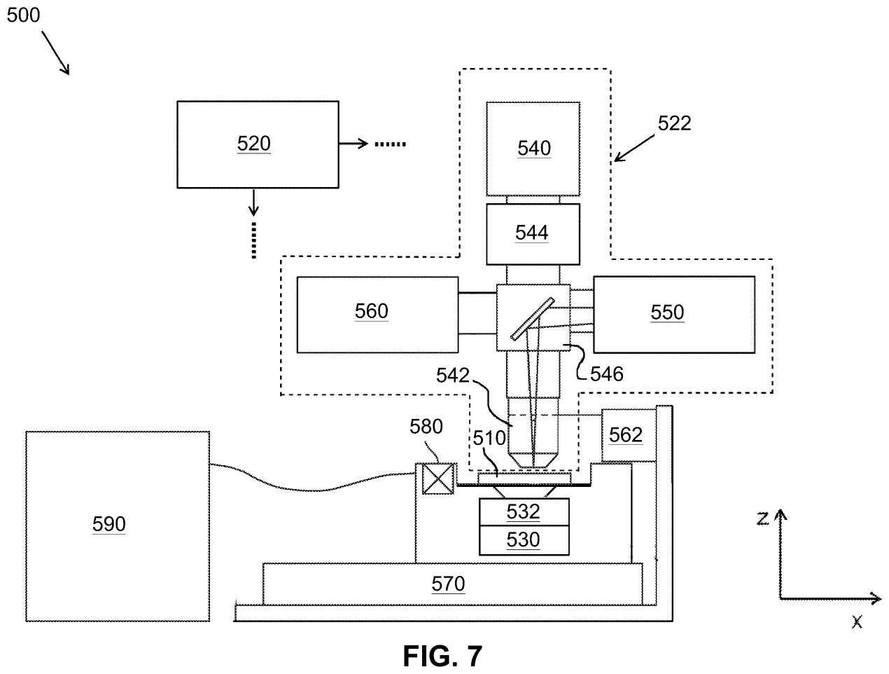

FIG. 7 illustrates a schematic diagram of another example of a system (500) that may be used to perform an analysis on one or more samples of interest. Except as otherwise described below, system (500) of this example may be configured and operable like systems (100, 300) described above. System (500) is configured to perform a large number of parallel reactions within a flow cell (510). Flow cell (510) may be configured and operable like flow cells (400, 450) described above or may have any other suitable configuration. Flow cell (510) may thus include one or more flow channels that receive a solution from system (500) and direct the solution toward reaction sites of flow cell (510).

System (500) includes a system controller (520) that may communicate with the various components, assemblies, and sub-systems of the system (500). Controller (520) may be configured and operable like controllers (114, 308) described above. An imaging assembly (522) of system (500) includes a light emitting assembly (550) that emits light that reaches reaction sites on flow cell (510). Light emitting assembly (550) may include an incoherent light emitter (e.g., emit light beams output by one or more excitation diodes), or a coherent light emitter such as emitter of light output by one or more lasers or laser diodes. In some implementations, light emitting assembly (550) may include a plurality of different light sources (not shown), each light source emitting light of a different wavelength range. Some versions of light emitting assembly (550) may also include one or more collimating lenses (not shown), a light structuring optical assembly (not shown), a projection lens (not shown) that is operable to adjust a structured beam shape and path, epifluorescence microscopy components, and/or other components. Although system (500) is illustrated as having a single light emitting assembly (550), multiple light emitting assemblies (550) may be included in some other implementations.

In the present example, the light from light emitting assembly (550) is directed by dichroic mirror assembly (546) through an objective lens assembly (542) onto a sample of a flow cell (510), which is positioned on a motion stage (570). In the case of fluorescent microscopy of a sample, a fluorescent element associated with the sample of interest fluoresces in response to the excitation light, and the resultant light is collected by objective lens assembly (542) and is directed to an image sensor of camera system (540) to detect the emitted fluorescence. In some implementations, a tube lens assembly may be positioned between the objective lens assembly (542) and the dichroic mirror assembly (546) or between the dichroic minor (546) and the image sensor of the camera system (540). A moveable lens element may be translatable along a longitudinal axis of the tube lens assembly to account for focusing on an upper interior surface or lower interior surface of the flow cell (510) and/or spherical aberration introduced by movement of the objective lens assembly (542).

In the present example, a filter switching assembly (544) is interposed between dichroic mirror assembly (546) and camera system (540). Filter switching assembly (544) includes one or more emission filters that may be used to pass through particular ranges of emission wavelengths and block (or reflect) other ranges of emission wavelengths. For example, emission filters may be used to direct different wavelength ranges of emitted light to different image sensors of the camera system (540) of imaging assembly (522). For instance, the emission filters may be implemented as dichroic mirrors that direct emission light of different wavelengths from flow cell (510) to different image sensors of camera system (540). In some variations, a projection lens is interposed between filter switching assembly (544) and camera system (540). Filter switching assembly (544) may be omitted in some versions.

System (500) further includes a fluid delivery assembly (590) that may direct the flow of reagents (e.g., fluorescently labeled nucleotides, buffers, enzymes, cleavage reagents, etc.) to (and through) flow cell (510) and waste valve (580). Fluid delivery assembly (590) may be configured and operable like the various fluid delivery components described above in the context of FIGS. 1-3. System (500) of the present example also includes a temperature station actuator (530) and heater/cooler (532) that may optionally regulate the temperature of conditions of the fluids within the flow cell (510). In some implementations, the heater/cooler (532) may be fixed to sample stage (570), upon which the flow cell (510) is placed, and/or may be integrated into sample stage (570).

Flow cell (510) may be removably mounted on sample stage (570), which may provide movement and alignment of flow cell (510) relative to objective lens assembly (542). Sample stage (570) may have one or more actuators to allow sample stage (570) to move in any of three dimensions. For example, actuators may be provided to allow sample stage (570) to move in the x, y, and z directions relative to objective lens assembly (542), tilt relative to objective lens assembly (542), and/or otherwise move relative to objective lens assembly (542). Movement of sample stage (570) may allow one or more sample locations on flow cell (510) to be positioned in optical alignment with objective lens assembly (542). Movement of sample stage (570) relative to objective lens assembly (542) may be achieved by moving sample stage (570) itself, by moving objective lens assembly (542), by moving some other component of imaging assembly (522), by moving some other component of system (500), or any combination of the foregoing. For instance, in some implementations, the sample stage (570) may be actuatable in the x and y directions relative to the objective lens assembly (542) while a focus component (562) or z-stage may move the objective lens assembly (542) along the z direction relative to the sample stage (570).

In some implementations, a focus component (562) may be included to control positioning of one or more elements of objective lens assembly (542) relative to the flow cell (510) in the focus direction (e.g., along the z-axis or z-dimension). Focus component (562) may include one or more actuators physically coupled to the objective lens assembly (542), the optical stage, the sample stage (570), or a combination thereof, to move flow cell (510) on sample stage (570) relative to the objective lens assembly (542) to provide proper focusing for the imaging operation. In the present example, the focus component (562) utilizes a focus tracking module (560) that is configured to detect a displacement of the objective lens assembly (542) relative to a portion of the flow cell (510) and output data indicative of an in-focus position to the focus component (562) or a component thereof or operable to control the focus component (562), such as controller (520), to move the objective lens assembly (542) to position the corresponding portion of the flow cell (510) in focus of the objective lens assembly (542).

In some implementations, an actuator of focus component (562) or for sample stage (570) may be physically coupled to objective lens assembly (542), the optical stage, sample stage (570), or a combination thereof, such as, for example, by mechanical, magnetic, fluidic, or other attachment or contact directly or indirectly to or with the stage or a component thereof. The actuator of focus component (562) may be configured to move objective lens assembly (542) in the z-direction while maintaining sample stage (570) in the same plane (e g, maintaining a level or horizontal attitude, perpendicular to the optical axis). In some implementations, sample stage (570) includes an x direction actuator and a y direction actuator to form an x-y stage. Sample stage (570) may also be configured to include one or more tip or tilt actuators to tip or tilt sample stage (570) and/or a portion thereof, to account for any slope in its surfaces.

Camera system (540) may include one or more image sensors to monitor and track the imaging (e.g., sequencing) of flow cell (510). Camera system (540) may be implemented, for example, as a CCD or CMOS image sensor camera, but other image sensor technologies (e.g., active pixel sensor) may be used. By way of further example only, camera system (540) may include a dual-sensor time delay integration (TDI) camera, a single-sensor camera, a camera with one or more two-dimensional image sensors, and/or other kinds of camera technologies. While camera system (540) and associated optical components are shown as being positioned above flow cell (510) in FIG. 7, one or more image sensors or other camera components may be incorporated into system (500) in numerous other ways as will be apparent to those skilled in the art in view of the teachings herein. For instance, one or more image sensors may be positioned under flow cell (510), such as within the sample stage (570) or below the sample stage (570); or may even be integrated into flow cell (510).

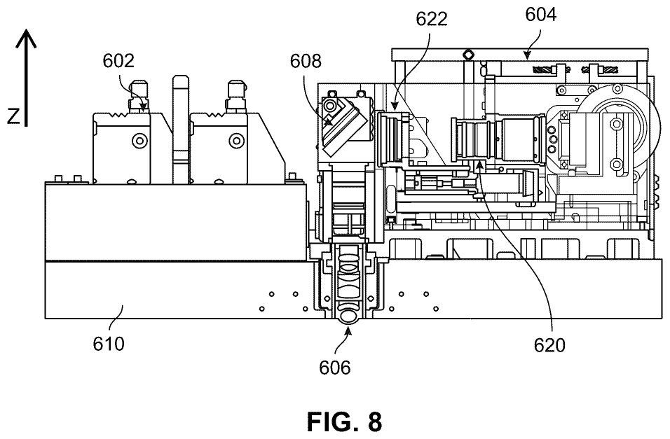

FIG. 8 shows an example of various components that may be integrated into imaging assembly (522) of system (500). In particular, the arrangement shown in FIG. 8 may represent a variation of light emitting assembly (550). The arrangement shown in FIG. 8 may be particularly useful in scenarios where camera system (540) includes a TDI camera. In the arrangement shown in FIG. 8, a line generation module (LGM) (602) and emission optics module (EOM) (604) are aligned and mechanically coupled to precision mounting plate (610), as well as to each other. EOM (604) includes an objective lens assembly (606) that is aligned, via a mirror (608) with a tube lens (620), which in turn is optically coupled to LGM (602). LGM (602) may include one or more light sources (e.g., coherent light sources such as laser diodes). In some examples, LGM (602) may include a first light source configured to emit light in red wavelengths, and a second light source configured to emit light in green wavelengths. LGM (602) may further include optical components, such as focusing surfaces, lenses, reflective surfaces, or minors. The optical components may be positioned within an enclosure of LGM (602) to direct and focus the light emitted from the one or more light sources into an adjacent modular subassembly. One or more of the optical components of LGM (602) may also be configured to shape the light emitted from the one or more light sources into desired patterns. For example, in some implementations, the optical components may shape the light into line patterns (e.g., by using one or more Powell lenses, or other beam shaping lenses, diffractive or scattering components). In some variations, LGM (602) may include one or more laser modules which may be individually removed from LGM (602) and replaced.

Light beams generated by LGM (602) transmit through an interface baffle between LGM (602) and EOM (604), pass through objective lens assembly (606), and strike an optical target (e.g., flow cell (510)). In some versions, the interface baffle includes an aperture shaped to enable light to pass through its center, while obscuring interference from external light sources. Responsive light radiation from the target may pass back through objective lens assembly (606) and into tube lens (622). A lens element (622), which may form part of tube lens (620), is configured to articulate along an axis (e.g., a z-axis) to correct for spherical aberration artifacts introduced by objective lens assembly (606) imaging through varied thickness of flow cell (510) components. As illustrated, lens element (622) may be articulated closer to or further away from objective lens assembly (606) to adjust the beam shape and path. Objective lens assembly (606) may emit excitation light toward the optical target (e.g., flow cell (510)) and receive fluorescence emission from the optical target. An actuator may be configured to position objective lens assembly (606) to a region of interest proximate to the optical target. The processor of controller (520) may then execute program instructions for detecting fluorescence emission from the optical target.

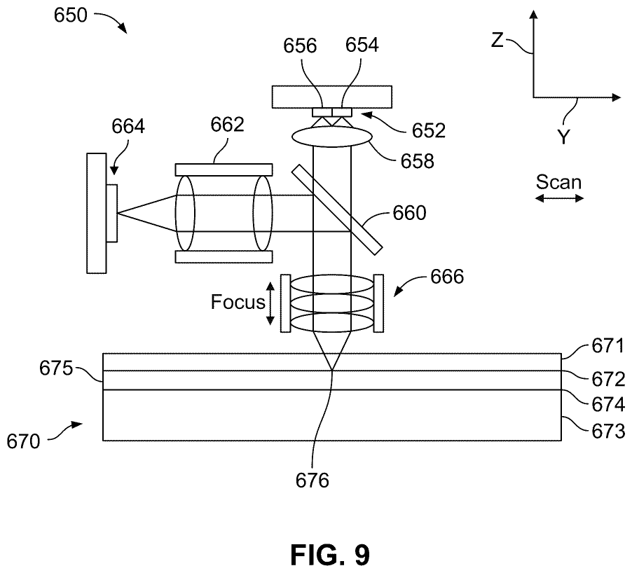

FIG. 9 shows an example of another configuration that may be provided in imaging assembly (522). In particular, FIG. 9 shows an imaging assembly (650) positioned in relation to a flow cell (670). Flow cell (670) may be representative of any of the variations of flow cells (128, 368, 400, 450, 510) described herein. Flow cell (670) has an upper layer (671) and a lower layer (673) that are separated by a fluid filled channel (675). In the configuration shown, upper layer (671) is optically transparent and imaging assembly (650) is focused to an area (676) on inner surface (672) of upper layer (671). In other variations, imaging assembly (650) may be focused on inner surface (674) of lower layer (673). One or both of surfaces (672, 674) may include array features that are to be detected by imaging assembly (650).

Imaging assembly (650) includes an objective lens assembly (666) that is configured to direct excitation radiation from a light emitting assembly (652) to flow cell (670); and to direct emission from flow cell (670) to a detector (664). In the arrangement shown, excitation radiation from light emitting assembly (652) passes through a lens (658), though a beam splitter (660), and through objective lens assembly (666) on to reach flow cell (670). In the present example, light emitting assembly (652) includes two light emitting diodes (LEDs) (656, 654), which produce radiation at different wavelengths from each other. The emission radiation from flow cell (670) is captured by objective lens assembly (666) and is reflected by beam splitter (660) through conditioning optics (662) and to detector (664) (e.g., a CMOS sensor). Beam splitter (660) functions to direct the emission radiation in a direction that is orthogonal to the path of the excitation radiation. The position of objective lens assembly (666) may be moved in the z dimension to alter focus of imaging assembly (650). The imaging assembly (650) may be moved back and forth in the y direction to capture images of several areas of at least one inner surface (672, 674) of flow cell (670).

In the present example, a single imaging assembly (650) includes two LEDs (656, 654) that emit light at two different respective wavelengths, with a single detector (664) detecting light emitted from fluorophore labels in flow cell (670) in response to irradiation at these two different wavelengths. In some other versions, there are two or more imaging assemblies (650), with each imaging assembly (650) including a single LED (656, 654) and a single detector (664), such that each imaging assembly (650) provides irradiation at only one single respective wavelength. As another variation, two or more detectors (664) may receive excitation radiation from a common light emitting assembly (652).

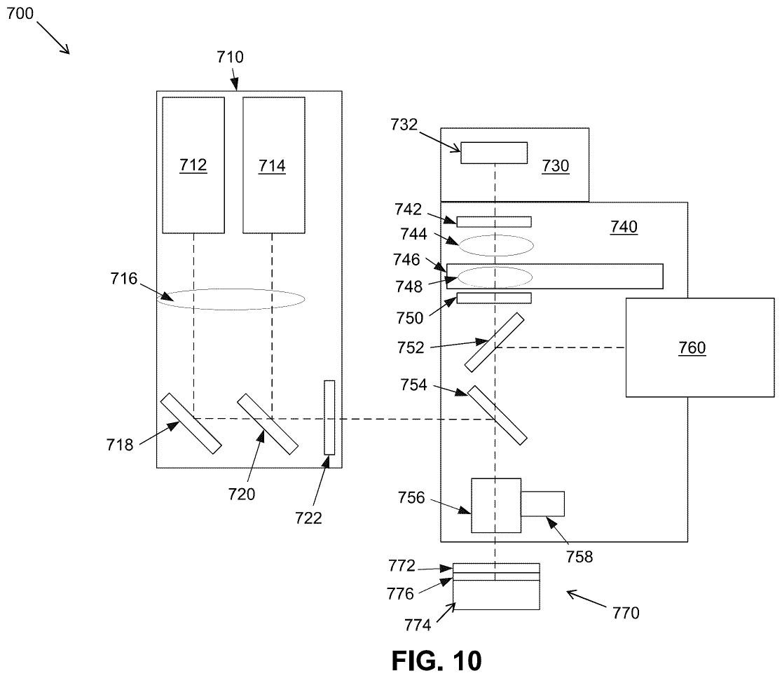

FIG. 10 shows an example of another configuration that may be provided in imaging assembly (522). In particular, FIG. 10 shows an imaging assembly (700) positioned in relation to a flow cell (774). Flow cell (774) may be representative of any of the variations of flow cells (128, 368, 400, 450, 510) described herein. Flow cell (770) has a translucent cover plate (772), a substrate (774), and a liquid layer (776) that is interposed between cover plate (772) and substrate (774). A biological sample may be located on an inside surface of cover plate (772) (above liquid layer (776)) and/or on an inside surface of substrate (774) (below liquid layer (776)).

Imaging assembly (700) of this example includes an LGM (710) with two light sources (712, 714), disposed therein. Light sources (712, 714) may include laser diodes, diode pumped solid state lasers, or other light sources as known in the art, which output laser beams at different wavelengths (e.g., red or green light). The light beams output from light sources (712, 714) are directed through a beam shaping lens or lenses (716). In some implementations, one or more light shaping lenses may be used to shape the light beams output from each or both light sources. LGM (710) may use one or more Powell lenses to spread and/or shape the laser beams from single or near-single mode laser light sources. Other beam shaping optics may be used to control uniformity and increase tolerance such as an active beam expander, an attenuator, one relay lenses, cylindrical lenses, actuated mirrors, diffractive elements, and scattering components. Laser beams may intersect at the back focal point of the objective lens to provide better tolerance on surfaces of flow cell (770).

LGM (710) of this example further includes mirrors (718, 720). A light beam generated by light source (712) reflects off minor (718), as to be directed through an aperture or semi-reflective surface of minor (720), and into EOM (740) through a single interface port. Similarly, a light beam generated by light source (714) reflects off minor (720) as to be directed into EOM (740) through a single interface port. In some examples, an additional set of articulating mirrors may be incorporated adjacent to minors (718, 720) to provide additional tuning surfaces. Both light beams may be combined using dichroic mirror (720). Minors (718, 720) may each be configured to articulate using manual or automated controls to align the light beams from light sources (712, 714). The light beams also pass through a shutter element (722) in the present example.

EOM (740) includes an objective lens assembly (756) and a z-stage (758), which moves objective lens assembly (756) longitudinally closer to or further away from flow cell (770). LGM (710) is configured to generate a uniform line illumination through objective lens assembly (756). Z-stage (758) may then move objective lens assembly (756) as to focus the light beams onto either of the inside surfaces of flow cell (770) (e.g., focused on a biological sample). In some implementations, the objective lens assembly (756) may be configured to focus the light beams at a focal point beyond flow cell (770), such as to increase the line width of the light beams at the surfaces of flow cell (770).

EOM (740) of the present example also include a semi-reflective minor (754) to direct light through objective lens assembly (756), while allowing light returned from flow cell (774) to pass through. EOM (740) further includes a tube lens (744) and a corrective lens (748). Corrective lens (748) may be articulated longitudinally by a z-stage (746), either closer to or further away from objective lens assembly (756), to ensure accurate imaging (e.g., to correct spherical aberration caused by moving objective lens assembly (756); and/or from imaging through a thicker substrate, etc.). Light transmitted through corrective lens (748) and tube lens (744) passes through filter element (742) and into camera system (730). Camera system (730) includes one or more optical sensors (732) to detect light emitted from the biological sample in response to the incident light beams.

In the present example, EOM (740) further includes semi-reflective mirror (752) to reflect a focus tracking light beam emitted from a focus tracking module (FTM) (760) onto flow cell (774), and then to reflect light returned from flow cell (774) back into FTM (760). FTM (760) may include a focus tracking optical sensor to detect characteristics of the returned focus tracking light beam and generate a feedback signal to optimize focus of objective lens assembly (756) on flow cell (774).

The direction, size, and/or polarization of the laser beams may be adjusted by using lenses, minors, and/or polarizers. Optical lenses (e.g., cylindrical, spherical, or aspheric) may be used to actively adjust the illumination focus on dual surfaces of the flow cell (770) target. LGM (710) may also include multiple units, with each unit being designed for particular/different wavelengths and polarization. Stacking multiple units may be used to increase the laser power and wavelength options. Two or more laser wavelengths may be combined with dichroics and polarizers.

By way of example only, focus tracking module (560) and/or other components of imaging assembly (522) may be constructed and operable in accordance with at least some of the teachings of U.S. Pat. No. 10,416,428, entitled “Systems and Methods for Improved Focus Tracking Using a Light Source Configuration,” issued Sep. 17, 2019, the disclosure of which is incorporated by reference herein, in its entirety; U.S. Pat. App. No. 63/300,531, entitled “Dynamic Detilt Focus Tracking,” filed Jan. 18, 2022, the disclosure of which is incorporated by reference herein, in its entirety; and/or U.S. Pat. App. No. 63/410,961, entitled “Spot Error Handling for Focus Tracking,” filed Sep. 28, 2022, the disclosure of which is incorporated by reference herein, in its entirety. By way of further example only, components of imaging assembly (522) may be configured and operable in accordance with at least some of the teachings of U.S. Pat. No. 10,774,371, entitled “Laser Line Illuminator for High Throughput Sequencing,” issued Sep. 15, 2020, the disclosure of which is incorporated by reference herein, in its entirety; and/ U.S. Pat. No. 9,958,465, entitled “Detection Apparatus having a Microfluorometer, a Fluidic System, and a Flow Cell Latch Clamp Module,” issued May 1, 2018, the disclosure of which is incorporated by reference herein, in its entirety.

### VI. Examples of Multispectral Imager

A. Multispectral Imaging Arrangement with Color Separation Assembly

It may be desirable to provide imaging in two or more spectral channels during a sequencing process. In some instances, light emitting assembly (550, 652) or a line generation module (LGM) (602, 710) may be configured to deliver multispectral light (i.e., light at multiple wavelengths) to two different locations on flow cell (128, 368, 400, 450, 510) simultaneously, such as through two or more excitation sources that produce excitation beams at different respective wavelengths. In some such scenarios, the corresponding emissions captured from reaction sites on flow cell (128, 368, 400, 450, 510) may also be at different respective wavelengths. There may be other scenarios in which fluorescent labels at reaction sites on flow cell (128, 368, 400, 450, 510) emit multispectral light in response to excitation from one or more irradiation sources like light emitting assembly (550, 652) or a line generation module (LGM) (602, 710).

In cases where fluorescent labels at reaction sites on flow cell (128, 368, 400, 450, 510) emit multispectral light in response to excitation from one or more irradiation sources like light emitting assembly (550, 652) or a line generation module (LGM) (602, 710), regardless of whether such multispectral light is being emitted from one spatial location on flow cell (128, 368, 400, 450, 510) or multiple spatial locations on flow cell (128, 368, 400, 450, 510), it may be desirable to provide an arrangement of optical features that provide spatial separation of the different wavelengths within the multispectral emitted light, while still maintaining fixed optical paths during sample scanning of reaction sites on flow cell (128, 368, 400, 450, 510). In some implementations, multiple-emission optical path control is facilitated by the use of multiple image sensors in camera system (540, 730), where the image sensors are displaced from one another.

In scenarios where different colors of a multispectral emission beam are spatially separated, it may be further desirable to minimize the number of tube lenses (620, 744), such that a single tube lens (620, 744) may be used despite the spatial separation of colors from a multispectral emission beam. Such minimization of the number of tube lenses (620, 744) in an imaging system (116, 310) or imaging assembly (522, 700) may minimize manufacturing costs and reduce risks associated with different magnification and distortion in each spectral channel, such as might occur due to manufacturing tolerance differences between two different optical components. As described in greater detail below, an imaging system (116, 310) or imaging assembly (522, 700) may achieve multispectral imaging (e.g., providing four or more spectral channels) using a single tube lens (620, 744) by including one or more compensating elements intended to induce astigmatism, without requiring any moving optics.

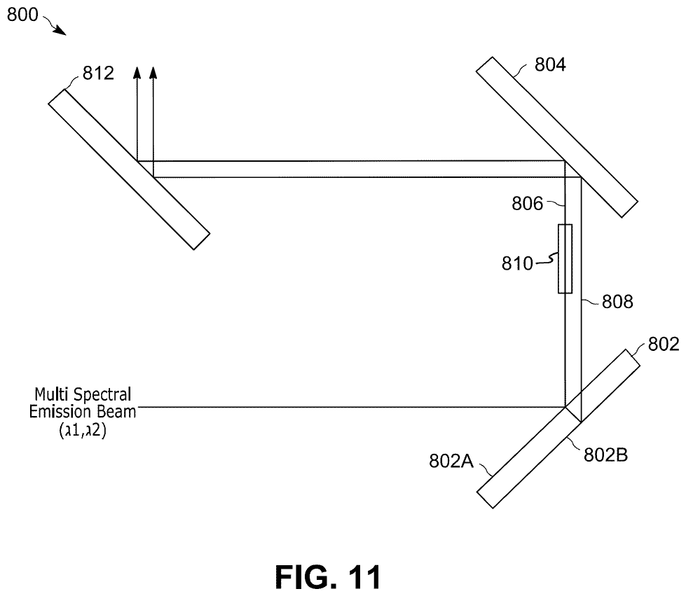

Wavelength separation of a multispectral beam may be achieved in using a color separation assembly (800) as shown in FIG. 11. Color separation assembly (800) of this example is used to separate wavelengths of multispectral beams emitted from reaction sites on flow cell (128, 368, 400, 450, 510), though color separation assembly (800) may alternatively be used to separate wavelengths of multispectral excitation beams or on any other suitable context. For instance, color separation assembly (800) may be placed in the optical path of two excitation beams from a single fiber, where such excitation beams are used to irradiate two separate locations on flow cell (128, 368, 400, 450, 510). It should also be understood that more than one color separation assembly (800) may be positioned in the excitation path(s) before flow cell (128, 368, 400, 450, 510); and/or more than one color separation assembly (800) may be positioned in the emission path(s) from flow cell (128, 368, 400, 450, 510).

Color separation assembly (800) of this example includes two angled reflectors (802, 804) forming a right-angle reflector. Color separation assembly (800) may be used in infinity space (e.g., collimated space between an objective lens assembly (542, 606, 666, 756) and a tube lens (620, 744)); in converging space (e.g., image space between a tube lens (620, 744) and one or more image sensors of camera system (540, 730)); or elsewhere. To compensate for a multispectral emission beam, reflector (802) is in the form of a dichroic that is configured to induce spatial separation of the emission beam into a first reflected wavelength beam from a first surface (802A) and a second reflected wavelength beam from a second surface (802B), generating two different respective beam paths (806, 808), one for each emission wavelength beam and based on a spacing gap between the first surface (802A) and the second surface (802B). For a smaller spacing gap then a smaller induced spatial separation may occur and for a larger spacing gap then a larger induced spatial separation may occur.

In the present example, a transparent optical compensation plate (810) is introduced into beam path (806) between reflectors (802, 804), to compensate for an optical path length difference imposed by the dichroic reflector (802). In some examples, the optical length and material of optical compensation plate (810) are determined based on the desired wavelength of the emission reflected at first surface (802A) and the amount of the optical path length delay induced by the size of the spacing gap between surfaces (802A, 802B) and the wavelength of the emission reflected at second surface (802B). In some versions, compensation plate (810) comprises an electro-optic compensator where the amount of optical compensation is controlled by signals from a controller (114, 308, 520). By way of further example only, compensation plate (810) may comprise a clocked compensator.

Because of compensation plate (810), the two spatially separated emission beam paths (806, 808) are incident with the same optical path entering an exit reflector (812) that couples the emission beams into a tube lens (620, 744) or into spaced apart image sensors (e.g., of camera system (540, 730)), depending on the implementation. In versions where color separation assembly (800) is positioned in converging space between a tube lens (620, 744) and two image sensors, each of those image sensors may be configured to capture a different respective emission wavelength (e.g., positioned in offset locations, provided with a wavelength bandpass filter, or using some other configuration). Some variations of color separation assembly (800) may omit one reflector (804, 812) or both reflectors (804, 812). Some other variations of color separation assembly (800) may include additional reflectors (not shown).

While reflector (802) is shown as a dichroic in this example, reflector (804) may be a dichroic in some variations. Moreover, both reflectors (802, 804) may be dichroic reflectors in some variations. In some variations, reflector (802) and/or reflector (804) may be composed of multiple discrete components or as a single assembly. Further, compensation plate (810) may alternatively be positioned between reflector (804) and exit reflector (812), to ensure that the two emission beams have the same optical path length. In some variations, an aperture may be introduced into one or both of the beam paths (806, 808) to prevent unwanted beam divergence and to ensure that objective lens assembly (542, 606, 666, 756) and tube lens (620, 744) form a sufficiently high-resolution relay lens configuration. For example, one or more apertures may be introduced to ensure that beam paths (806, 808) properly coincide with an entrance aperture of tube lens (620, 744).

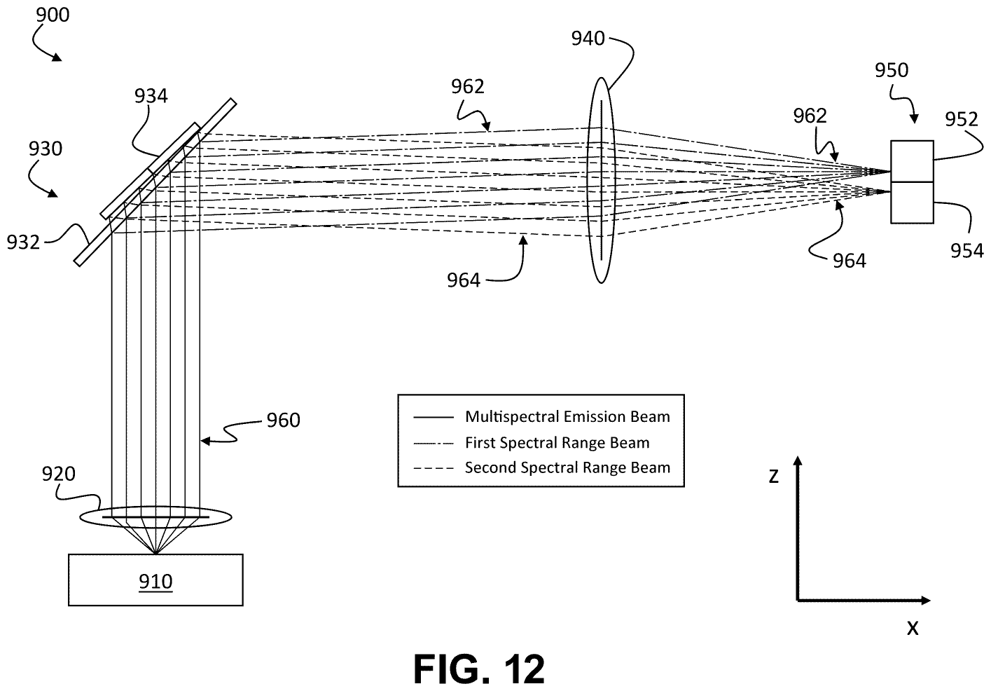

FIG. 12 shows an example of an arrangement (900) in which a color separation assembly (930) is positioned within a collimated/infinity space between an objective lens assembly (920) and a tube lens (940). Arrangement (900) may be integrated into any of the various imaging systems (116, 310) or imaging assemblies (522, 700) described herein; or in any other suitable imaging context. Objective lens assembly (920) and tube lens (940) are each shown schematically in FIG. 12. It should be understood that objective lens assembly (920) may include any suitable number of lens elements and/or other optical features; and tube lens (940) may include any suitable number of lens elements and/or other optical features. Objective lens assembly (920) is positioned over a flow cell (910), which may be configured and operable like any of the variations of flow cells (128, 368, 400, 450, 510) described herein.

In the present example, florescent labels at reaction sites on flow cell (910) emit light in response to excitation from one or more excitation light sources (not shown); and the multispectral emission beam (960) is transmitted through objective lens assembly (920) to reach color separation assembly (930). Objective lens (920) of this example is configured to substantially collimate multispectral emission beam (960), such that color separation assembly (930) is in collimated/infinity space of multispectral emission beam (960). In the present example, multispectral emission beam (960) is generated from just one spatial location on flow cell (910). In some other variations, multispectral emission beam (960) is generated from two or more different spatial locations on flow cell (910). In some such variations, two or more excitation light sources are used to simultaneously irradiate different respective spatial locations on flow cell (910). Such different excitation light sources may emit excitation light at different respective wavelengths. It should therefore be understood that there may be arrangements where there are two or more multispectral emission beams (960) generated from two or more different respective spatial locations on flow cell (910), such that a flow cell (910) may have two or more multispectral emission points simultaneously.

Color separation assembly (930) of this example includes a filtering reflector element (932) and a reflector element (934) positioned behind filtering reflector element (932). Filtering reflector element (932) is configured to reflect light of multispectral emission beam (960) within a first spectral range; while allowing light of multispectral emission beam (960) within a second spectral range to pass through and reach reflector element (934). In FIG. 12, the reflected light within the first spectral range is represented by beam (962); while the reflected light within the second spectral range is represented by beam (964). While color separation assembly (930) is described herein as being formed of two separate components including filtering reflector element (932) and reflector element (934), some variations may provide a color separation assembly (930) formed by a single component or element (e.g., wedged optic, etc.), such that not all forms of color separation assembly (930) need necessarily be formed of two separate components. In the present example, reflector element (934) comprises a simple minor that reflects light within the second spectral range as represented by beam (964). In some other versions, reflector element (934) comprises a dichroic element, such that reflector element (934) is configured to transmit light outside the second spectral range while reflecting light within the second spectral range. It should therefore be understood that terms such as “reflector element,” “reflective element,” and the like may include simple minors, dichroic elements, or other elements capable of reflecting light.

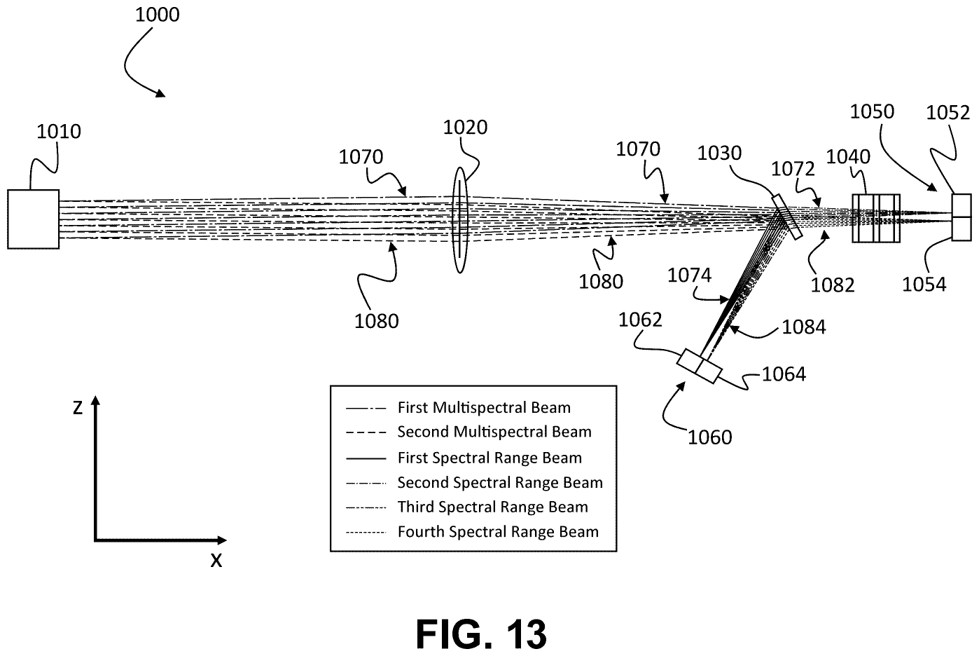

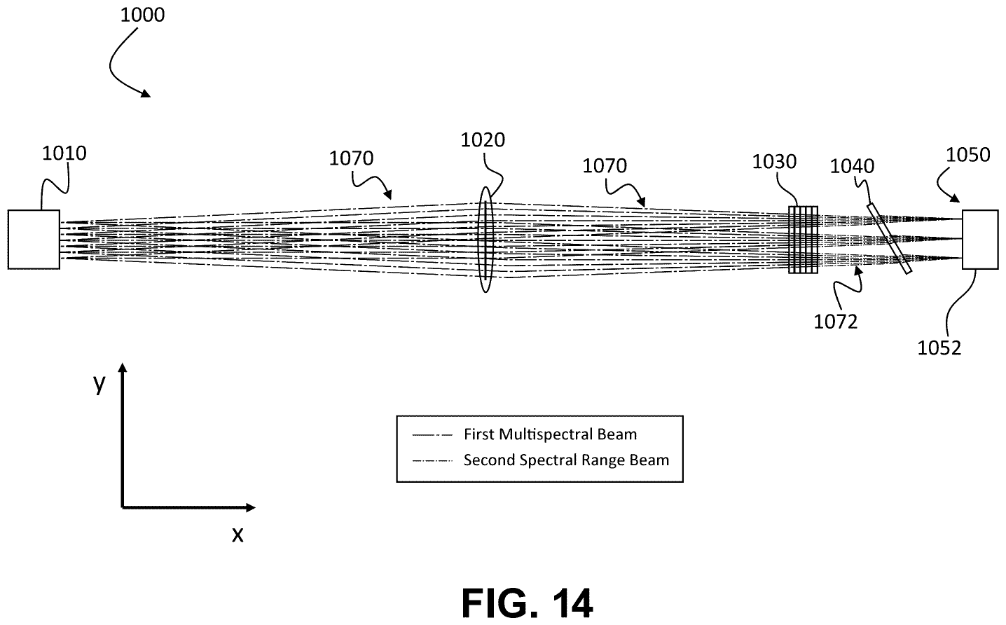

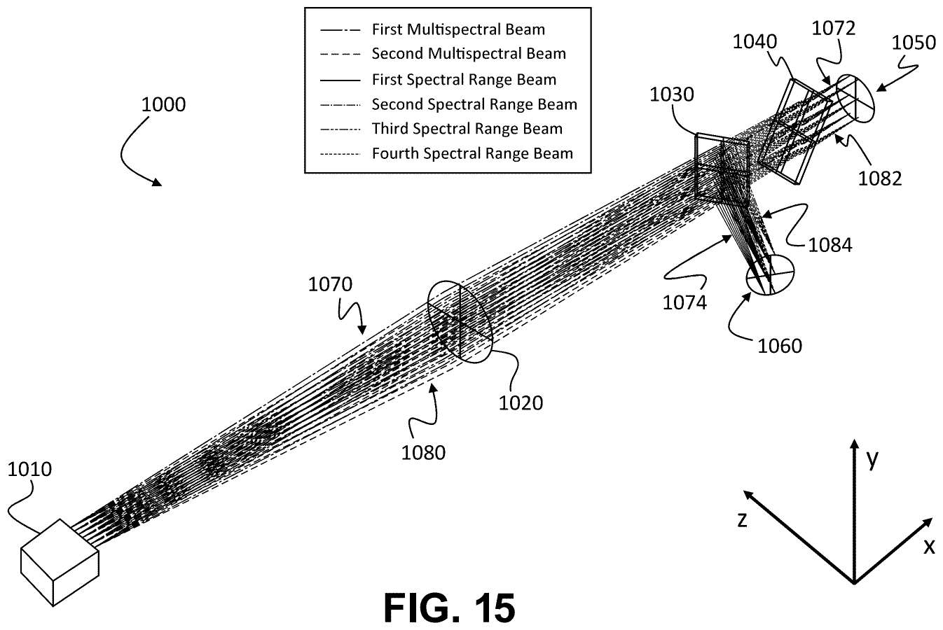

In some variations, filtering reflector element (932) is in the form of a dichroic element. For instance, filtering reflector element (932) may be configured to reflect light of one color (e.g., blue) while allowing light of another color (e.g., green) to pass through to reach reflector element (934). In some other variations, filtering reflector element (932) is in the form of a multiband beamsplitter. For instance, filtering reflector element (932) may be configured to reflect two colors (e.g., blue and red) while allowing two other colors (e.g., green and orange) to pass through to reach reflector element (934). The colors referenced above are merely illustrative examples and are not intended to be limiting in any way. In scenarios where the first spectral range (reflected by filtering reflector element (932)) includes two or more colors and the second spectral range (reflected by reflector element (934)) includes two or more colors, beams (962, 964) may receive further color separation as described below with reference to FIGS. 13-15.

In the present example, filtering reflector element (932) and reflector element (934) are not parallel with each other. Thus, filtering reflector element (932) is tilted about the y-axis at a first angle while reflector element (934) is tilted about the y-axis at a second angle. (It should be understood that the x-axis and the z-axis shown in FIG. 12 do not necessarily correspond with the same axes as shown in other drawings.) By way of example only, filtering reflector element (932) and reflector element (934) may be angularly offset from each other by approximately 1 degree. Alternatively, filtering reflector element (932) and reflector element (934) may have any other suitable angular offset. In any case, the angular offset between filtering reflector element (932) and reflector element (934) will provide a corresponding angular offset between first spectral range beam (962) and second spectral range beam (964). This differentiates color separation assembly (930) of FIG. 12 from color separation assembly (800) of FIG. 11.

While the spatial distance between the reflective surfaces of filtering reflector element (932) and reflector element (934) will already provide a spatial offset between first spectral range beam (962) and second spectral range beam (964) (similar to the spatial offset provided in the arrangement of FIG. 11, as described above); the additional angular offset between first spectral range beam (962) and second spectral range beam (964) may effectively further enhance the spatial offset between first spectral range beam (962) and second spectral range beam (964), particularly as a function of distance “downstream” of color separation assembly (930). Thus, depending on whatever kind(s) of additional optical components are positioned “downstream” of color separation assembly (930), where those additional optical components are positioned “downstream” of color separation assembly (930), the angular offset between filtering reflector element (932) and reflector element (934) may be adjusted to provide the preferred degree of spatial separation between beams (962, 964).

In the present example, tube lens (940) is positioned “downstream” of color separation assembly (930), such that both beams (962, 964) pass through tube lens (940) into a converging image space. The images formed at the focus of tube lens (940) are transversely separated from each other, due to the angular and spatial separation between beams (962, 964) as described above. A camera (950) is positioned in the converging image spaces created by tube lens (940) to thereby capture these two images. By way of example only, camera (950) may comprise a TDI camera. Camera (950) includes a first image sensor (952) and a second image sensor (954). Image sensors (952, 954) are positioned adjacent to each other in this example. Image sensor (952) is positioned to receive first spectral range beam (962); while image sensor (954) is positioned to receive second spectral range beam (964). Arrangement (900) thus allows a single camera (950) to simultaneously capture images in two separate color channels, with two respective image sensors (952, 954), from a single multispectral beam (960) emitted from a single flow cell (910), using just one single objective lens assembly (920) and just one single tube lens (940).

B. Multispectral Imaging Arrangement with One Astigmatism Compensation Element

As noted above, there may be some scenarios where a first spectral range (e.g., as reflected by filtering reflector element (932)) includes two or more colors and a second spectral range (e.g., as reflected by reflector element (934)) includes two or more colors. In some such scenarios, a multispectral emission beam (like multispectral beam (960)) may include meaningful optical data within more than two spectral channels (e.g., within more than two colors), such that it may be desirable to ultimately separate the multispectral emission beam into more than two spectral ranges for capture via more than two respective image sensors. FIGS. 13-15 show an example of an arrangement (1000) where a multispectral emission beam (like multispectral beam (960)) may be further separated into four spectral ranges for capture via four respective image sensors (1052, 1054, 1062, 1064).

In arrangement (1000), a first multispectral beam (1070) is transmitted from a color separation assembly (1010) along a first spatial orientation while a second multispectral beam (1080) is transmitted from color separation assembly (1010) along a second spatial orientation. By way of example only, color separation assembly (1010) of arrangement (1000) may be configured and operable like color separation assembly (930) of arrangement (900). Likewise, first multispectral beam (1070) may be angularly and spatially offset from second multispectral beam (1070) like first beam (962) is angularly and spatially offset from second beam (964). It should also be understood that arrangement (1000) may include a flow cell and objective lens assembly like flow cell (910) and objective lens assembly (920), respectively, such that color separation assembly (1010) separates a multispectral emission beam from the flow cell into first multispectral beam (1070) and second multispectral beam (1070).

Beams (1070, 1080) pass through tube lens (1020) and eventually reach a dichroic element (1030), which is positioned in converging image space between tube lens (1020) and a first camera (1050). Dichroic element (1030) is tilted at a first tilt angle about the y-axis in the present example. (It should be understood that the x, y, and z axes shown in FIGS. 13-15 do not necessarily correspond with the same axes as shown in other drawings.) Dichroic element (1030) is configured such that dichroic element (1030) will reflect light of first multispectral beam (1070) in a first spectral range; while allowing light of first multispectral beam (1070) in a second spectral range to pass through dichroic element (1030). Similarly, dichroic element (1030) is configured such that dichroic element will reflect light of second multispectral beam (1080) in a third spectral range; while allowing light of second multispectral beam (1080) in a fourth spectral range to pass through dichroic element (1030). In FIGS. 13-15, the light within the first spectral range is represented by beam (1072); within the second spectral range by beam (1074); within the third spectral range by beam (1082); and within the fourth spectral range by beam (1084). By way of example only, the first spectral range may include red, the second spectral range may include blue, the third spectral range may include green, and the fourth spectral range may include orange. The colors referenced here are merely illustrative examples and are not intended to be limiting in any way.

Due to the spatial separation between beams (1070, 1080) within the converging image space, beams (1070, 1080) are incident upon dichroic element (1030) at two different respective regions. Thus, beams (1074, 1084) reflect off dichroic element (1030) at two different respective regions; and beams (1072, 1082) pass through dichroic element at two different respective regions. A second camera (1060) is positioned to capture beams (1074, 1084). In particular, the images formed at the focus of tube lens (1020) are transversely separated from each other, due to the angular and spatial separation between beams (1074, 1084) as described above. Second camera (1060) is positioned in the converging image spaces created by tube lens (1020) to thereby capture these two images. By way of example only, second camera (1060) may comprise a TDI camera. Second camera (1060) includes a first image sensor (1062) and a second image sensor (1064). Image sensors (1062, 1064) are positioned adjacent to each other in this example. Image sensor (1062) is positioned to receive first spectral range beam (1074); while image sensor (1064) is positioned to receive second spectral range beam (1064).

As noted above, beams (1072, 1082) pass through dichroic element (1030) in this example. The passage of beams (1072, 1082) through dichroic element (1030) may induce an astigmatism in beams (1072, 1082). To compensate for this astigmatism, a compensation element (1040) is positioned in the path of beams (1072, 1082) between dichroic element (1030) and first camera (1050). By way of example only, compensation element (1040) may comprise a flat plate or have any other suitable configuration. Compensation element (1040) is configured to induce an astigmatism in beams (1072, 1082) that offsets or effectively cancels out the astigmatism induced in beams (1072, 1082) by dichroic element (1030). Compensation element (1040) is tilted at a second tilt angle about the z-axis. (As noted above, the x, y, and z axes shown in FIGS. 13-15 do not necessarily correspond with the same axes as shown in other drawings.) Compensation element (1040) and dichroic element (1030) are thus tilted about respective axes that are orthogonal to each other in this example. In some versions, the first tilt angle and the second tilt angle are equal. Compensation element (1040) may be configured with a tilt angle, thickness, and material selected to compensate aberrations of dichroic element (1030).

The astigmatism-corrected beams (1072, 1082) are captured by first camera (1050). In particular, the images formed at the focus of tube lens (1020) are transversely separated from each other, due to the angular and spatial separation between beams (1072, 1082) as described above. First camera (1050) is positioned in the converging image spaces created by tube lens (1020) to thereby capture these two images, with the astigmatism correction provided by compensation element (1040). By way of example only, first camera (1050) may comprise a TDI camera. First camera (1050) includes a first image sensor (1052) and a second image sensor (1054). Image sensors (1052, 1054) are positioned adjacent to each other in this example. As noted above, due to the spatial separation between beams (1070, 1080) within the converging image space, beams (1070, 1080) are incident upon dichroic element (1030) at two different respective regions, such that beams (1072, 1082) pass through dichroic element (1030) at two different respective regions. Image sensor (1052) is positioned to receive third spectral range beam (1072); while image sensor (1054) is positioned to receive fourth spectral range beam (1082).

In view of the foregoing, arrangement (1000) allows two cameras (1050, 1060) to simultaneously capture images in four separate color channels, with four respective image sensors (1052, 1054, 1062, 1064), from a single multispectral beam emitted from a single flow cell, using just one single objective lens assembly and just one single tube lens (1020) in combination with a color separation assembly (1010).

C. Multispectral Imaging Arrangement with Two Astigmatism Compensation Elements

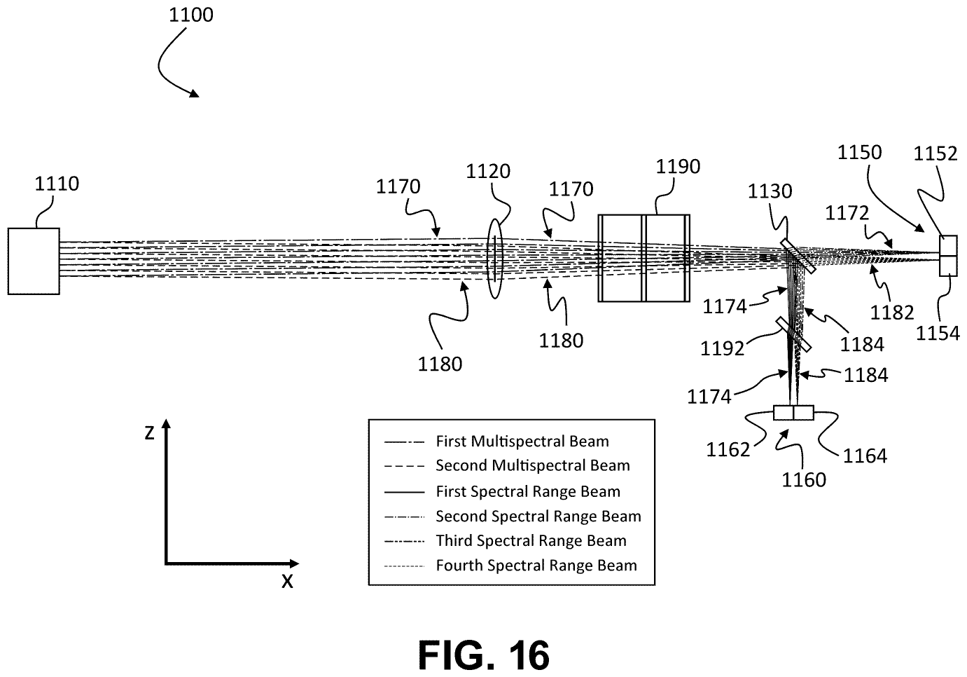

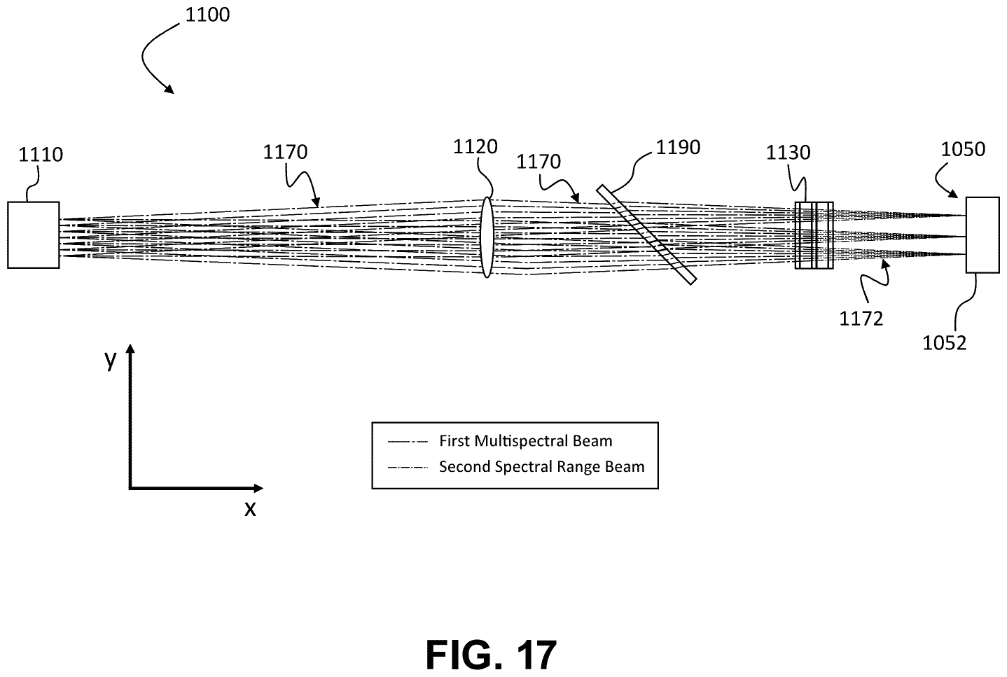

FIGS. 16-17 show another example of an arrangement that allows two cameras (1150, 1160) to simultaneously capture images in four separate color channels, with four respective image sensors (1152, 1154, 1162, 1164), from a single multispectral beam emitted from a single flow cell, using just one single objective lens assembly and just one single tube lens (1120) in combination with a color separation assembly (1110). In arrangement (1100), a first multispectral beam (1170) is transmitted from a color separation assembly (1110) along a first spatial orientation while a second multispectral beam (1180) is transmitted from color separation assembly (1110) along a second spatial orientation. By way of example only, color separation assembly (1110) of arrangement (1100) may be configured and operable like color separation assembly (930) of arrangement (900). Likewise, first multispectral beam (1170) may be angularly and spatially offset from second multispectral beam (1180) like first beam (962) is angularly and spatially offset from second beam (964). It should also be understood that arrangement (1100) may include a flow cell and objective lens assembly like flow cell (910) and objective lens assembly (920), respectively, such that color separation assembly (1110) separates a multispectral emission beam from the flow cell into first multispectral beam (1170) and second multispectral beam (1170).

Beams (1170, 1180) pass through tube lens (1120) and eventually reach a first compensation element (1190), which is positioned in converging image space between tube lens (1120) and a dichroic element (1130). First compensation element (1190) is tilted at a first tilt angle about the z-axis in the present example. (It should be understood that the x, y, and z axes shown in FIGS. 16-17 do not necessarily correspond with the same axes as shown in other drawings.) By way of example only, first compensation element (1140) may comprise a flat plate or have any other suitable configuration. First compensation element (1140) is configured to induce an astigmatism in beams (1170, 1180). First compensation element (1140) may be configured with a tilt angle, thickness, and material selected to compensate aberrations of a dichroic element (1130) as described below.

Dichroic element (1130) is also positioned in the converging image space, between first compensation element (1190) and first camera (1150). Dichroic element (1130) is tilted at a second tilt angle about the y-axis in the present example. (As noted above, the x, y, and z axes shown in FIGS. 16-17 do not necessarily correspond with the same axes as shown in other drawings.) Dichroic element (1130) is configured such that dichroic element (1130) will reflect light of first multispectral beam (1170) in a first spectral range; while allowing light of first multispectral beam (1170) in a second spectral range to pass through dichroic element (1130). Similarly, dichroic element (1130) is configured such that dichroic element will reflect light of second multispectral beam (1180) in a third spectral range; while allowing light of second multispectral beam (1180) in a fourth spectral range to pass through dichroic element (1130). In FIGS. 16-17, the light within the first spectral range is represented by beam (1172); within the second spectral range by beam (1174); within the third spectral range by beam (1182); and within the fourth spectral range by beam (1184). By way of example only, the first spectral range may include red, the second spectral range may include blue, the third spectral range may include green, and the fourth spectral range may include orange. The colors referenced here are merely illustrative examples and are not intended to be limiting in any way.

Beams (1174, 1184) reflected from dichroic element (1130) pass through a second compensation element (1192) before reaching a second camera (1160). By way of example only, second compensation element (1192) may comprise a flat plate or have any other suitable configuration. Second compensation element (1192) is configured to induce an astigmatism in beams (1174, 1184). In particular, the astigmatism induced in beams (1174, 1184) by second compensation element (1192) offsets or effectively cancels out the astigmatism induced in beams (1174, 1184) by first compensation element (1190). Second compensation element (1192) is tilted at a third tilt angle about the z y-axis in the present example. (As noted above, the x, y, and z axes shown in FIGS. 16-17 do not necessarily correspond with the same axes as shown in other drawings.) First and second compensation elements (1190, 1192) are thus tilted about respective axes that are orthogonal to each other in this example. In some versions, the first tilt angle and the third tilt angle are equal. Second compensation element (1192) may be configured with a tilt angle, thickness, and material selected to compensate aberrations of first compensation element (1190).

The astigmatism-corrected beams (1174, 1184) are captured by second camera (1160). In particular, the images formed at the focus of tube lens (1120) are transversely separated from each other, due to the angular and spatial separation between beams (1174, 1184) as described above. Second camera (1160) is positioned in the converging image spaces created by tube lens (1120) to thereby capture these two images. By way of example only, second camera (1160) may comprise a TDI camera. Second camera (1160) includes a first image sensor (1162) and a second image sensor (1164). Image sensors (1162, 1164) are positioned adjacent to each other in this example. As noted above, due to the spatial separation between beams (1170, 1180) within the converging image space, beams (1170, 1180) are incident upon dichroic element (1130) at two different respective regions, such that beams (1072, 1082) reflect off dichroic element (1130) at two different respective regions. Image sensor (1162) is positioned to receive first spectral range beam (1174); while image sensor (1164) is positioned to receive second spectral range beam (1164).

As noted above, beams (1172, 1182) pass through dichroic element (1130) in this example. The passage of beams (1172, 1182) through dichroic element (1130) may induce an astigmatism in beams (1172, 1182). This astigmatism induced by dichroic element (1130) may effectively offset or cancel out the astigmatism induced in beams (1170, 1180) by first compensation element (1190). As noted above, dichroic element (1130) is tilted at a second tilt angle about the y-axis. (As also noted above, the x, y, and z axes shown in FIGS. 13-15 do not necessarily correspond with the same axes as shown in other drawings.) First compensation element (1190) and dichroic element (1130) are thus tilted about respective axes that are orthogonal to each other in this example. In some versions, the first tilt angle (of first compensation element (1190)) and the second tilt angle (of dichroic element (1130)) are equal. Moreover, the second tilt angle (of dichroic element (1130)) and the third tilt angle (of second compensation element (1192)) may be equal, such that dichroic element (1130) and second compensation element (1192) may be parallel with each other.

The astigmatism-corrected beams (1172, 1182) are captured by first camera (1150). In particular, the images formed at the focus of tube lens (1120) are transversely separated from each other, due to the angular and spatial separation between beams (1172, 1182) as described above. First camera (1150) is positioned in the converging image spaces created by tube lens (1120) to thereby capture these two images. By way of example only, first camera (1150) may comprise a TDI camera. First camera (1150) includes a first image sensor (1152) and a second image sensor (1154). Image sensors (1152, 1154) are positioned adjacent to each other in this example. As noted above, due to the spatial separation between beams (1170, 1180) within the converging image space, beams (1170, 1180) are incident upon dichroic element (1130) at two different respective regions, such that beams (1172, 1182) pass through dichroic element (1130) at two different respective regions. Image sensor (1152) is positioned to receive third spectral range beam (1172); while image sensor (1154) is positioned to receive fourth spectral range beam (1182).

In view of the foregoing, arrangement (1100) allows two cameras (1150, 1160) to simultaneously capture images in four separate color channels, with four respective image sensors (1152, 1154, 1162, 1164), from a single multispectral beam emitted from a single flow cell, using just one single objective lens assembly and just one single tube lens (1120) in combination with a color separation assembly (1110).

D. Multispectral Imaging Arrangement with Non-Adjacent Image Sensors

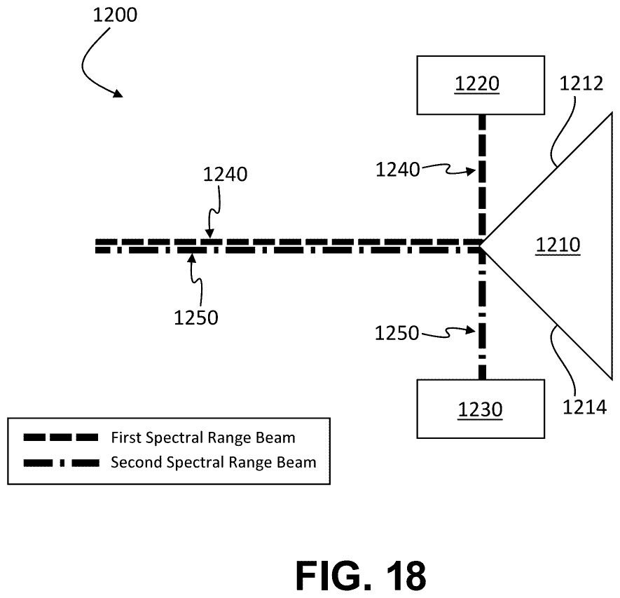

In arrangements (900, 1000, 1100) described above, each camera (950, 1050, 1060, 1150, 1160) includes a respective pair of adjacent image sensors (952, 954, 1052, 1054, 1152, 1154, 1162, 1164). In some scenarios, it may be desirable to modify arrangements (900, 1000, 1100) to allow two spectrally-different yet spatially-adjacent beams (962, 964, 1072, 1074, 1082, 1084, 1172, 1174, 1182, 1184) to be captured by non-adjacent image sensors. FIG. 18 shows an example of an arrangement (1200) that may be used to redirect two spectrally-different yet spatially-adjacent beams (1240, 1250) toward respective non-adjacent image sensors (1220, 1230). In this example, first beam (1240) is within a first spectral range (e.g., blue) while second beam (1250) is within a second spectral range (e.g., red). Beams (1240, 1250) may be transmitted from a color separation assembly (800, 930, 1010, 1110) as described herein or from any other suitable source.

Beams (1240, 1250) are adjacent to, and parallel with, each other until reaching a diverting element (1210). In some other variations, beams (1240, 1250) are not parallel with each other. Diverting element (1210) has a first reflective surface (1212) and a second reflective surface (1214). Surfaces (1210, 1212) define a right angle with each other in this example, though surfaces (1210, 1212) may alternatively define any other suitable angle with each other. Surface (1212) is positioned to receive and reflect first beam (1240) toward a first image sensor (1220). Surface (1214) is positioned to receive and reflect second beam (1250) toward a second image sensor (1230). Image sensors (1220, 1230) are oriented to face each other in this example. In other versions, image sensors (1220, 1230) have some other spatial relationship and orientation relative to each other; and the configuration of diverting element (1210) is modified to accommodate such alternative spatial relationships/orientations. By way of example only, diverting element (1210) may comprise a knife-edge right-angle prism mirror. Alternatively, diverting element (1210) may take any other suitable form.

In the context of arrangement (900), image sensors (952, 954) may be rearranged such that they are positioned similar to image sensors (1220, 1230); and a diverting element (1210) may be positioned to redirect beam (962) toward image sensor (952) while redirecting beam (964) toward image sensor (954). In the context of arrangement (1000), image sensors (1052, 1054) may be rearranged such that they are positioned similar to image sensors (1220, 1230); and a diverting element (1210) may be positioned to redirect beam (1072) toward image sensor (1052) while redirecting beam (1082) toward image sensor (1054). Similarly, image sensors (1062, 1064) may be rearranged such that they are positioned similar to image sensors (1220, 1230); and a diverting element (1210) may be positioned to redirect beam (1074) toward image sensor (1062) while redirecting beam (1084) toward image sensor (1064). In the context of arrangement (1100), image sensors (1152, 1154) may be rearranged such that they are positioned similar to image sensors (1220, 1230); and a diverting element (1210) may be positioned to redirect beam (1172) toward image sensor (1152) while redirecting beam (1182) toward image sensor (1154). Similarly, image sensors (1162, 1164) may be rearranged such that they are positioned similar to image sensors (1220, 1230); and a diverting element (1210) may be positioned to redirect beam (1174) toward image sensor (1162) while redirecting beam (1184) toward image sensor (1164).

Any of the arrangements (900, 1000, 1100) described above may be used in scenarios where an excitation source irradiates reaction sites at one single location on a flow cell (128, 368, 400, 450, 510, 910); or at two or more different locations (simultaneously) on a flow cell (128, 368, 400, 450, 510, 910). Moreover, any of the arrangements (900, 1000, 1100) described above may be used in scenarios where an excitation source irradiates reaction sites with light in two different wavelengths at two or more different locations (simultaneously) on a flow cell (128, 368, 400, 450, 510, 910). In the examples described above, arrangements (900, 1000, 1100) separate emission from two object points (e.g., on a flow cell (128, 368, 400, 450, 510, 910)) into four image points (e.g., at image sensors (952, 954, 1052, 1054, 1152, 1154, 1162, 1164)). Some variations may separate emission from more than two object points. Similarly, some variations may separate emission into two, three, or more than four image points.

In some variations where an excitation source irradiates reaction sites with light in two different wavelengths at two or more different locations (simultaneously) on a flow cell (128, 368, 400, 450, 510, 910), the emission beams from those two or more different locations will already have spatial separation (and also spectral separation in some cases). In such scenarios it may not be necessary to include the spatial and angular separation functionalities of color separation assemblies (800, 930, 1010, 1110) as described above. Instead, a dichroic element (1030, 1130) may be positioned in the collimated space to provide further separation within the two or more multispectral emission beams. In some such cases, a single dichroic element (1030, 1130) may be used for all of the two or more multispectral emission beams. In some other cases, each of the two or more multispectral emission beams may have its own respective dichroic element (1030, 1130). Alternatively, a color separation assembly (800, 930, 1010, 1110) may be positioned in the path of each multispectral emission beam to direct emission beams in certain wavelength ranges toward corresponding image sensors (952, 954, 1052, 1054, 1152, 1154, 1162, 1164).

As yet another variation, dichroic elements (1030, 1130) of arrangements (1000, 1100) may be replaced with dual-bandpass optical filters. Filtering reflector element (932) of arrangement (900) may also be replaced with a dual-bandpass optical filter. If a filter in collimated/infinite space (e.g., filtering reflector element (932)) is long-pass, then the filter in the converging/image space (e.g., dichroic element (1030, 1130)) may have a single passband that comprises the middle two sets of wavelengths or can use a dual passband filter.

It should be understood from the foregoing that multispectral light emitted from reaction sites on a flow cell (128, 368, 400, 450, 510, 910) (or from any other kind of irradiated sample) may be separated into any number of spectral channels by spatial separation of the emission points (e.g., by irradiating two or more different points on the sample), by separation of the emission beam into two or more spectral channels in collimated/infinite space, and/or by separation of the emission beam into two or more spectral channels in converging image space. Moreover, the teachings herein may be applied in contexts where more than two fields of view are being imaged simultaneously; and where two, three, or more than four spectral channels are being imaged simultaneously. It should also be understood that color separation stages need not necessarily have spectral symmetry. For example, a color separation assembly may divide three colors into a first channel with two colors and a second channel with just one color.

### VII. Examples of Combinations

The following examples relate to various non-exhaustive ways in which the teachings herein may be combined or applied. The following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### EXAMPLE 1

An apparatus, comprising: a sample stage region configured to provide an object plane; an optical assembly including: an objective element providing a field of view, the object plane being within the field of view, a tube lens, the tube lens being configured to receive light transmitted through the objective element, a first dichroic element, the optical assembly being configured to transmit light in at least a first color channel, a second color channel, a third color channel, and a fourth color channel from the tube lens toward the first dichroic element, the first dichroic element being configured to transmit light of the first and third color channels while reflecting light of the second and fourth color channels, the first dichroic element being further configured to induce a first astigmatism in the first and third color channels, and a compensating element, the compensating element being configured to induce a second astigmatism in the first and third color channels, the second astigmatism being configured to offset the first astigmatism; and a camera assembly configured to receive the light of the first, second, third, and fourth color channels.

### EXAMPLE 2

The apparatus of Example 1, the first and second color channels being angularly offset from the third and fourth color channels at a plane of incidence on the first dichroic element.

### EXAMPLE 3

The apparatus of Example 2, the optical assembly further comprising a color shaping assembly, the color shaping assembly being configured to provide the angular offset of light of the first and second color channels from light of the third and fourth color channels.

### EXAMPLE 4

The apparatus of Example 3, the color shaping assembly including a second dichroic element and a reflective element, the reflective element being angularly offset relative to the second dichroic element.

### EXAMPLE 5

The apparatus of Example 4, the second dichroic element being configured to reflect light of the first and second color channels, the second dichroic element being further configured to provide transmission of light of the third and fourth color channels to the reflective element, the reflective element being configured to reflect light of the third and fourth color channels.

### EXAMPLE 6

The apparatus of any of Examples 3 through 5, the color shaping assembly being positioned in an optical path between the objective element and the tube lens.

### EXAMPLE 7

The apparatus of any of Examples 1 through 6, further comprising an excitation assembly, the excitation assembly being operable to emit light toward two different regions within the object plane, the first and second color channel being associated with a first region of the two different regions, the third and fourth color channel being associated with a second region of the two different regions.

### EXAMPLE 8

The apparatus of any of Examples 1 through 7, the first dichroic element being interposed between the tube lens and the camera assembly.

### EXAMPLE 9

The apparatus of any of Examples 1 through 8, the first dichroic element comprising a first plate tilted about a first axis at a first angle.

### EXAMPLE 10

The apparatus of Example 9, the compensating element comprising a second plate tilted about a second axis at a second angle.

### EXAMPLE 11

The apparatus of Example 10, the second axis being orthogonal to the first axis.

### EXAMPLE 12

The apparatus of any of Examples 10 through 11, the second angle being equal to the first angle.

### EXAMPLE 13

The apparatus of any of Examples 1 through 12, the camera assembly comprising: a first image sensor configured to receive light of the first color channel, a second image sensor configured to receive light of the second color channel, a third image sensor configured to receive light of the third color channel, and a fourth image sensor configured to receive light of the fourth color channel.

### EXAMPLE 14

The apparatus of Example 13, the first image sensor being positioned adjacent to the third image sensor, the second image sensor being positioned adjacent to the fourth image sensor.

### EXAMPLE 15

The apparatus of Example 14, the camera assembly comprising a first time delay and integration (TDI) camera and a second TDI camera.

### EXAMPLE 16

The apparatus of Example 15, the first TDI camera including the first and third image sensors, the second TDI camera including the second and fourth image sensors.

### EXAMPLE 17

The apparatus of any of Examples 15 through 16, the first TDI camera being oriented along a first axis, the second TDI camera being oriented along a second axis, the second axis being perpendicular to the first axis.

### EXAMPLE 18

The apparatus of Example 13, the camera assembly further comprising: a first reflective member, the first reflective member being configured to reflect light of the first color channel toward the first image sensor, the first reflective member being further configured to reflect light of the third color channel toward the third image sensor, and a second reflective member, the second reflective member being configured to reflect light of the second color channel toward the second image sensor, the second reflective member being further configured to reflect light of the first color channel toward the first image sensor.

### EXAMPLE 19

The apparatus of Example 18, the first reflective member comprising a first right-angle prism minor, the second reflective member comprising a second right-angle prism mirror.

### EXAMPLE 20

An apparatus, comprising: an objective element providing a field of view; a tube lens, the tube lens being configured to receive light transmitted through the objective element, the tube lens being further configured to transmit light including spatially offset spectral channels through a convergent image space; a dichroic element within the convergent image space, the dichroic element being configured to reflect light of at least one light channel within the convergent image space while transmitting light of at least one other light channel within the convergent image space, the dichroic element being further configured to induce an astigmatism in the light transmitted through the dichroic element; and a compensating element, the compensating element being configured to induce a second astigmatism in the light transmitted through the dichroic element, the second astigmatism being configured to offset the first astigmatism.

### EXAMPLE 21

A method comprising: transmitting light from a tube lens through a dichroic element, the transmitted light including a first color channel, a second color channel, a third color channel, and a fourth color channel, the first and second color channels being spatially offset from the third and fourth color channels at a plane of incidence on the dichroic element; transmitting light of the first and third color channels through the dichroic element, the dichroic element inducing a first astigmatism in the first and third color channels; reflecting light of the second and fourth color channels, the light of the second and fourth color channels being reflected by the dichroic element; transmitting light of the first and third color channels from the dichroic element through a compensating element, the compensating element inducing a second astigmatism in the first and third color channels, the second astigmatism offsetting the first astigmatism; receiving light of the first and third color channels from the compensating element at a camera assembly; and receiving light of the second and fourth color channels from the dichroic element at the camera assembly.

### VIII. Miscellaneous

While the foregoing examples are provided in the context of a system (100) that may be used in nucleotide sequencing processes, the teachings herein may also be readily applied in other contexts, including in systems that perform other processes (i.e., other than nucleotide sequencing procedures). The teachings herein are thus not necessarily limited to systems that are used to perform nucleotide sequencing processes.

It is to be understood that the subject matter described herein is not limited in its application to the details of construction and the arrangement of components set forth in the description herein or illustrated in the drawings hereof. The subject matter described herein is capable of other implementations and of being practiced or of being carried out in various ways. Also, it is to be understood that the phraseology and terminology used herein is for the purpose of description and should not be regarded as limiting. As used herein, an element or step recited in the singular and proceeded with the word “a” or “an” should be understood as not excluding plural of said elements or steps, unless such exclusion is explicitly stated. Furthermore, references to “one example” are not intended to be interpreted as excluding the existence of additional examples that also incorporate the recited features. The use of “including,” “comprising,” or “having” and variations thereof herein is meant to encompass the items listed thereafter and equivalents thereof as well as additional items.

When used in the claims, the term “set” should be understood as one or more things which are grouped together. Similarly, when used in the claims “based on” should be understood as indicating that one thing is determined at least in part by what it is specified as being “based on.” Where one thing is required to be exclusively determined by another thing, then that thing will be referred to as being “exclusively based on” that which it is determined by.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. Also, it is to be understood that phraseology and terminology used herein with reference to device or element orientation (such as, for example, terms like “above,” “below,” “front,” “rear,” “distal,” “proximal,” and the like) are only used to simplify description of one or more examples described herein, and do not alone indicate or imply that the device or element referred to must have a particular orientation. In addition, terms such as “outer” and “inner” are used herein for purposes of description and are not intended to indicate or imply relative importance or significance.

It is to be understood that the above description is intended to be illustrative, and not restrictive. For example, the above-described examples (and/or aspects thereof) may be used in combination with each other. In addition, many modifications may be made to adapt a particular situation or material to the teachings of the presently described subject matter without departing from its scope. While the dimensions, types of materials and coatings described herein are intended to define the parameters of the disclosed subject matter, they are by no means limiting and instead illustrations. Many further examples will be apparent to those of skill in the art upon reviewing the above description. The scope of the disclosed subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112(f) paragraph, unless and until such claim limitations expressly use the phrase “means for” followed by a statement of function void of further structure.

The following claims recite aspects of certain examples of the disclosed subject matter and are considered to be part of the above disclosure. These aspects may be combined with one another.

What is claimed is:

1. An apparatus, comprising:
a sample stage region configured to provide an object plane;
an optical assembly including:
an objective element providing a field of view, the object plane being within the field of view,
a tube lens, the tube lens being configured to receive light transmitted through the objective element,
a first dichroic element, the optical assembly being configured to transmit light in at least a first color channel, a second color channel, a third color channel, and a fourth color channel from the tube lens toward the first dichroic element, the first dichroic element being configured to transmit light of the first and third color channels while reflecting light of the second and fourth color channels, the first dichroic element being further configured to induce a first astigmatism in the first and third color channels, and
a compensating element, the compensating element being configured to induce a second astigmatism in the first and third color channels, the second astigmatism being configured to offset the first astigmatism; and
a camera assembly configured to receive the light of the first, second, third, and fourth color channels.

2. The apparatus of claim 1, the first and second color channels being angularly offset from the third and fourth color channels at a plane of incidence on the first dichroic element.

3. The apparatus of claim 2, the optical assembly further comprising a color shaping assembly, the color shaping assembly being configured to provide the angular offset of light of the first and second color channels from light of the third and fourth color channels.

4. The apparatus of claim 3, the color shaping assembly including a second dichroic element and a reflective element, the reflective element being angularly offset relative to the second dichroic element.

5. The apparatus of claim 4, the second dichroic element being configured to reflect light of the first and second color channels, the second dichroic element being further configured to provide transmission of light of the third and fourth color channels to the reflective element, the reflective element being configured to reflect light of the third and fourth color channels.

6. The apparatus of claim 3, the color shaping assembly being positioned in an optical path between the objective element and the tube lens.

7. The apparatus of claim 1, further comprising an excitation assembly, the excitation assembly being operable to emit light toward two different regions within the object plane, the first and second color channel being associated with a first region of the two different regions, the third and fourth color channel being associated with a second region of the two different regions.

8. The apparatus of claim 1, the first dichroic element being interposed between the tube lens and the camera assembly.

9. The apparatus of claim 1, the first dichroic element comprising a first plate tilted about a first axis at a first angle.

10. The apparatus of claim 9, the compensating element comprising a second plate tilted about a second axis at a second angle.

11. The apparatus of claim 10, the second axis being orthogonal to the first axis.

12. The apparatus of claim 10, the second angle being equal to the first angle.

13. The apparatus of claim 1, the camera assembly comprising:
a first image sensor configured to receive light of the first color channel,
a second image sensor configured to receive light of the second color channel,
a third image sensor configured to receive light of the third color channel, and
a fourth image sensor configured to receive light of the fourth color channel.

14. The apparatus of claim 13, the first image sensor being positioned adjacent to the third image sensor, the second image sensor being positioned adjacent to the fourth image sensor.

15. The apparatus of claim 14, the camera assembly comprising a first time delay and integration (TDI) camera and a second TDI camera, the first TDI camera including the first and third image sensors, the second TDI camera including the second and fourth image sensors.

16. The apparatus of claim 15, the first TDI camera being oriented along a first axis, the second TDI camera being oriented along a second axis, the second axis being perpendicular to the first axis.

17. The apparatus of claim 13, the camera assembly further comprising:
a first reflective member, the first reflective member being configured to reflect light of the first color channel toward the first image sensor, the first reflective member being further configured to reflect light of the third color channel toward the third image sensor, and
a second reflective member, the second reflective member being configured to reflect light of the second color channel toward the second image sensor, the second reflective member being further configured to reflect light of the first color channel toward the first image sensor.

18. The apparatus of claim 17, the first reflective member comprising a first right-angle prism mirror, the second reflective member comprising a second right-angle prism minor.

19. An apparatus, comprising:
an objective element providing a field of view;
a tube lens, the tube lens being configured to receive light transmitted through the objective element, the tube lens being further configured to transmit light including spatially offset spectral channels through a convergent image space;
a dichroic element within the convergent image space, the dichroic element being configured to reflect light of at least one light channel within the convergent image space while transmitting light of at least one other light channel within the convergent image space, the dichroic element being further configured to induce an astigmatism in the light transmitted through the dichroic element; and
a compensating element, the compensating element being configured to induce a second astigmatism in the light transmitted through the dichroic element, the second astigmatism being configured to offset the first astigmatism.

20. A method comprising:
transmitting light from a tube lens through a dichroic element, the transmitted light including a first color channel, a second color channel, a third color channel, and a fourth color channel, the first and second color channels being spatially offset from the third and fourth color channels at a plane of incidence on the dichroic element;
transmitting light of the first and third color channels through the dichroic element, the dichroic element inducing a first astigmatism in the first and third color channels;
reflecting light of the second and fourth color channels, the light of the second and fourth color channels being reflected by the dichroic element;
transmitting light of the first and third color channels from the dichroic element through a compensating element, the compensating element inducing a second astigmatism in the first and third color channels, the second astigmatism offsetting the first astigmatism;
receiving light of the first and third color channels from the compensating element at a camera assembly; and
receiving light of the second and fourth color channels from the dichroic element at the camera assembly.
